(19) United States
(12) Patent Application Publication
(10) Pub. No.: US 2025/0126674 A1
(43) Pub. Date: Apr. 17, 2025

(54) Managing Radio Functions in the Inactive State

(71) Applicant: GOOGLE LLC, Mountain View, CA (US)

(72) Inventor: Chih-Hsiang Wu, Taoyuan City (TW)

(21) Appl. No.: 18/293,767

(22) PCT Filed: Jul. 29, 2022
(86) PCT No.: PCT/US2022/038789

§ 371 Date: Jan. 30, 2024

Related U.S. Application Data
(60) Provisional application No. 63/227,414, filed on Jul. 30, 2021.

(51) Int. Cl. H04W 76/27

(52) U.S. Cl. CPC H04W 76/27

(57) ABSTRACT

A central unit (CU) of a distributed base station, the distributed base station including the CU and a distributed unit (DU), can implement a method for managing a radio function for communicating with a UE. The method may include determining (1202) to transmit a CU-to-DU message, related to control of data communication with the UE, to the DU, and determining (1204) whether the data communication requires the DU to perform the radio function. The method further includes, based on whether the data communication requires the DU to perform the radio function, determining (1206) whether to include an indication in the CU-to-DU message to enable the radio function at the DU. The method also includes transmitting (1208) the CU-to-DU message to the DU.

### FIELD OF THE DISCLOSURE

This disclosure relates generally to wireless communications and, more particularly, to communication of uplink and/or downlink data at a user equipment (UE) when the UE operates in an inactive, idle state, or connected state associated with a protocol for controlling radio resources.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Generally, a base station operating a cellular radio access network (RAN) communicates with a user equipment (UE) using a certain radio access technology (RAT) and multiple layers of a protocol stack. For example, the physical layer (PHY) of a RAT provides transport channels to the Medium Access Control (MAC) sublayer, which in turn provides logical channels to the Radio Link Control (RLC) sublayer, and the RLC sublayer in turn provides data transfer services to the Packet Data Convergence Protocol (PDCP) sublayer. The Radio Resource Control (RRC) sublayer is disposed above the PDCP sublayer.

The RRC sublayer specifies the RRC_IDLE state, in which a UE does not have an active radio connection with a base station; the RRC_CONNECTED state, in which the UE has an active radio connection with the base station; and the RRC_INACTIVE state to allow a UE to more quickly transition back to the RRC_CONNECTED state due to Radio Access Network (RAN)-level base station coordination and RAN-paging procedures. In some cases, the UE in the RRC_IDLE or RRC_INACTIVE state has only one, relatively small packet to transmit. In these cases, the UE in the RRC_IDLE or RRC_INACTIVE state can perform an early data transmission without transitioning to the RRC_CONNECTED state, e.g., by using techniques as specified in section 7.3a-7.3d in 3GPP specification 36.300 v16.4.0.

However, implementing data communication techniques while the UE is in an inactive state (e.g., RRC_INACTIVE) or an idle state (e.g., RRC_IDLE), i.e., early data communication presents several challenges. In particular, a 5G NR radio access network (i.e., an NG-RAN) may include distributed base stations, where each distributed base station includes a central unit (CU) and at least one distributed unit (DU). While operating in a connected state (e.g., RRC_CONNECTED), a UE can use configuration parameters in one or more radio configurations (e.g., CellGroupConfig IE, MeasConfig IE, RadioResourceConfigDedicated IE) to perform various radio functions related to communicating with a DU and a CU. After the UE transitions to the inactive state or the idle state, the UE and the CU may retain the configuration parameters.

While the UE operates in the inactive state, the UE does not perform certain radio functions related to the retained parameters. However, the DU may still attempt to perform corresponding radio functions (e.g., when performing early data communication with the UE). As a result, the DU may perform radio functions that the UE does not, or cannot, perform while operating in the inactive state. For example, a radio configuration for a UE may include configuration parameters for a discontinuous reception (DRX) operation and/or a measurement gap operation. However, the UE may be unable to perform DRX operations or measurement gap operations when operating in the inactive state. Because the DU is not aware that the UE is operating in the inactive state, the DU refrains from scheduling the UE during an off-duration in a DRX cycle or during measurement gaps, which may unnecessarily cause the UE to spend additional time and power while performing early data communication. As another example, the UE may be unable to measure reference signals when operating in the inactive state, but the DU may unnecessarily use resources to transmit a reference signal to the UE.

### SUMMARY

Network nodes of a radio access network (RAN) can use the techniques of this disclosure to manage a radio function for communicating with a UE. As used in this disclosure, early data communication can refer to early data transmission (EDT) from the perspective of the network (i.e., EDT in the downlink direction), or EDT from the perspective of the UE (i.e., EDT in the uplink direction).

In some implementations, a central unit (CU) of a distributed base station manages whether the DU enables a radio function for communicating with a UE. The CU, for example, may transmit a CU-to-DU message (e.g., a UE Context Setup Request message) to a distributed unit (DU) related to data communication with a UE. Based on whether the data communication requires the DU to perform the radio function, the CU can determine whether to include an indication in the CU-to-DU message to enable the radio function at the DU. If the data does require the DU to perform the radio function, the CU can include the indication in the CU-to-DU message. Otherwise, the CU can exclude the indication from the CU-to-DU message. The indication may be a configuration for the radio function, or may be an information element (IE) formatted in accordance with a protocol for signaling between the CU and the DU (e.g., an F1 Application Protocol (F1AP) or W1 Application Protocol (W1AP)). Further, the CU may indicate, in the CU-to-DU message, whether the CU is performing early data communication with the UE via the DU.

In other implementations, the DU manages whether the DU enables the radio function for communicating with a UE. In particular, the DU may determine whether the UE is operating in an inactive state (e.g., RRC_INACTIVE). The DU can then determine whether to enable the radio function based on whether the UE is operating in the inactive state. For example, the DU may determine that the UE is operating in the inactive state in response to determining that the DU is performing early data communication with the UE. If the UE is operating in the inactive state, the DU refrains from enabling the radio function. Otherwise, the DU enables the radio function.

The radio function that the CU or the DU either enables or refrains from enabling may be a radio function for communicating with the UE when the UE operates in a connected state (e.g., RRC_CONNECTED), such as a discontinuous reception (DRX) operation, a measurement gap operation, or a reference signal transmission.

One example embodiment of these techniques is a method implemented in a CU of a distributed base station, the distributed base station including the CU and a DU, for managing a radio function for communicating with a UE. The method can be executed by processing hardware and includes: determining to transmit a CU-to-DU message, related to control of data communication with the UE, to the DU; determining whether the data communication requires the DU to perform the radio function; based on whether the data communication requires the DU to perform the radio function, determining whether to include an indication in the CU-to-DU message to enable the radio function at the DU; and transmitting the CU-to-DU message to the DU.

Another example embodiment of these techniques is a method implemented in a DU of a distributed base station, the distributed base station including the DU and a CU, for managing a radio function for communicating with a UE. The method can be executed by processing hardware and includes: determining whether the UE is operating in an inactive state associated with a protocol for controlling radio resources; and determining, whether to enable the radio function at the DU based on whether the UE is operating in the inactive state.

Yet another example embodiment of these techniques is a network node of a distributed base station including processing hardware and configured to implement any one of the methods above.

### BRIEF DESCRIPTION OF THE DRAWINGS

FIG. 1A is a block diagram of an example wireless communication system in which a base station can implement the techniques of this disclosure for managing early data communication between the UE and a radio access network (RAN);

FIG. 1B is a block diagram of an example base station including a central unit (CU) and a distributed unit (DU) that can operate in the system of FIG. 1A;

FIG. 2A is a block diagram of an example protocol stack according to which the UE of FIG. 1A can communicate with base stations;

FIG. 2B is a block diagram of an example protocol stack according to which the UE of FIG. 1A can communicate with a DU and a CU of a base station;

FIG. 3A is an example message sequence in which a CU and a DU of a distributed base station perform early data communication with a UE operating in an inactive state, and the DU refrains from applying a radio configuration in response to determining that the DU is performing early data communication;

FIG. 3B is an example message sequence in which a CU and a DU of a distributed base station perform early data communication with a UE operating in an inactive state, and the CU refrains from sending a radio configuration to the DU in response to determining that the CU is performing early data communication;

FIG. 3C and FIG. 3D are example message sequences similar to the message sequences of FIG. 3A and FIG. 3B, respectively, but where the UE changes coverage areas after transitioning to the inactive state;

FIG. 3E is an example message sequence similar to the message sequence of FIG. 3A or FIG. 3B, but where the DU applies the radio configuration when the distributed base station transitions the UE to a connected state;

FIG. 3F is an example message sequence similar to the message sequence of FIG. 3E, but where the DU updates the radio configuration and applies the updated radio configuration;

FIG. 3G is an example message sequence similar to the message sequence of FIG. 3E, but where the DU releases the radio configuration instead of applying the configuration;

FIG. 4 is a flow diagram of an example method for determining whether to apply a radio configuration based on whether a DU is performing early data communication, which can be implemented by the DU;

FIG. 5 is a flow diagram of an example method for determining whether to enable a radio function for communicating with a UE based on whether a DU is performing early data communication with the UE, which can be implemented by the DU;

FIG. 6 is a flow diagram of an example method for determining whether to enable a radio function for communicating with a UE after receiving a CU-to-DU information element (IE) related to the radio function from a CU, which can be implemented by a DU;

FIG. 7 is a flow diagram of an example method for determining whether to enable a radio function for communicating with a UE based on whether a DU has received an EDT indication from a CU, which can be implemented by the DU;

FIG. 8 is a flow diagram of an example method for determining whether to cause a DU to enable a radio function for communicating with a UE based on whether a CU is performing early data communication with the UE, which can be implemented by the CU;

FIG. 9 is a flow diagram of an example method for determining whether to transmit a CU-to-DU IE related to a radio function for communicating with a UE based on whether a CU is performing early data communication with the UE, which can be implemented by the CU;

FIG. 10 is a flow diagram of an example method for determining whether to include an EDT indication in a CU-to-DU message based on whether a CU is performing early data communication with a UE, which can be implemented by the CU;

FIGS. 11A-11B are flow diagrams of example methods for transitioning a UE from an inactive state to a connected state, which can be implemented by a CU;

FIG. 12 is a flow diagram for managing a radio function for communicating with a UE, which can be implemented by a CU; and

FIG. 13 is a flow diagram for managing a radio function for communicating with a UE, which can be implemented by a DU.

### DETAILED DESCRIPTION OF THE DRAWINGS

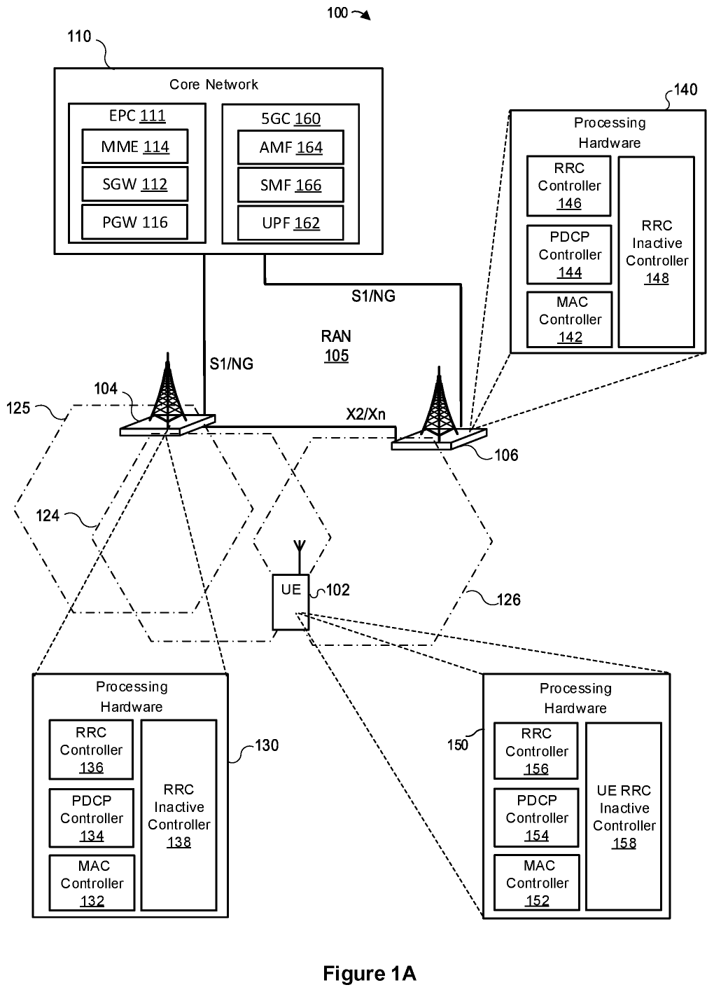

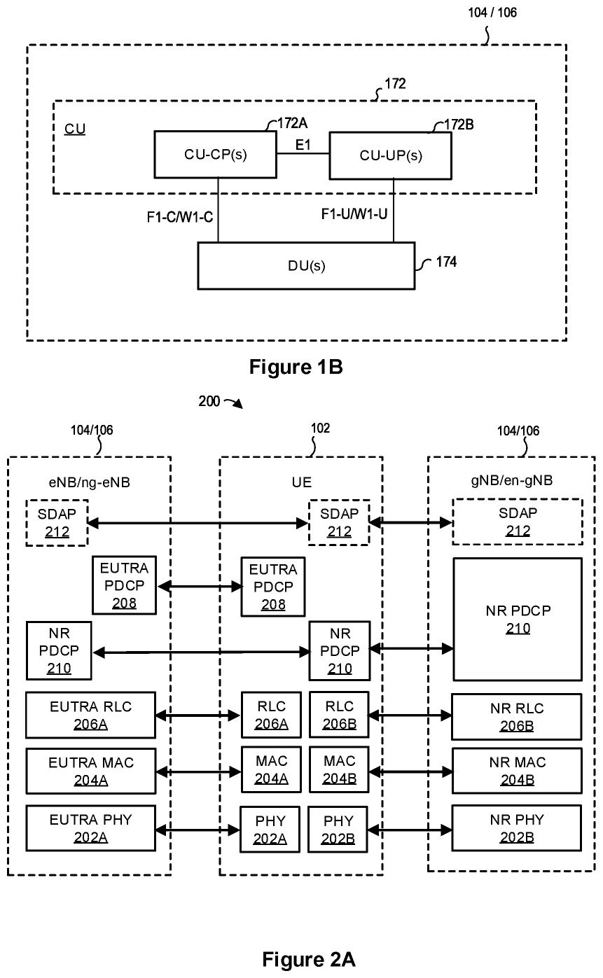

Referring first to FIG. 1A, an example wireless communication system 100 includes a UE 102, a base station (BS) 104, a base station 106, and a core network (CN) 110. The base stations 104 and 106 can operate in a RAN 105 connected to the core network (CN) 110. The CN 110 can be implemented as an evolved packet core (EPC) 111 or a fifth generation (5G) core (5GC) 160, for example. The CN 110 can also be implemented as a sixth generation (6G) core in another example.

The base station 104 covers a cell 124, and the base station 106 covers a cell 126. If the base station 104 is a gNB, the cell 124 is an NR cell. If the base station 104 is an ng-eNB, the cell 124 is an evolved universal terrestrial radio access (E-UTRA) cell. Similarly, if the base station 106 is a gNB, the cell 126 is an NR cell, and if the base station 106 is an ng-eNB, the cell 126 is an E-UTRA cell. The cells 124 and 126 can be in the same Radio Access Network Notification Arcas (RNA) or different RNAs. In general, the RAN 105 can include any number of base stations, and each of the base stations can cover one, two, three, or any other suitable number of cells. The UE 102 can support at least a 5G NR (or simply, “NR”) or E-UTRA air interface to communicate with the base stations 104 and 106. Each of the base stations 104, 106 can connect to the CN 110 via an interface (e.g., S1 or NG interface). The base stations 104 and 106 also can be interconnected via an interface (e.g., X2 or Xn interface) for interconnecting NG RAN nodes.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management Function (AMF) 164, and/or Session Management Function (SMF) 166. Generally speaking, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

As illustrated in FIG. 1A, the base station 104 supports a cell 124, and the base station 106 supports a cell 126. The cells 124 and 126 can partially overlap, so that the UE 102 can select, reselect, or hand over from one of the cells 124 and 126 to the other. To directly exchange messages or information, the base station 104 and base station 106 can support an X2 or Xn interface. In general, the CN 110 can connect to any suitable number of base stations supporting NR cells and/or EUTRA cells.

As discussed in detail below, the RAN 105 can utilize the techniques of this disclosure for communicating with the UE 102 when the radio connection between the UE 102 and the RAN 105 is suspended, e.g., when the UE operates in an inactive or idle state of the protocol for controlling radio resources between the UE 102 and the RAN 105. For clarity, the examples below refer to the RRC_INACTIVE or RRC_IDLE state of the RRC protocol.

As used in this disclosure, the term “data” or “data packet” refers to signaling, control-plane information at a protocol layer of controlling radio resources (e.g., RRC); controlling mobility management (MM); controlling session management (SM); or non-signaling, non-control-plane information at protocol layers above the layer of the protocol for controlling radio resources (e.g., RRC), above the layer of the protocol for controlling mobility management (MM), above the layer of the protocol for controlling session management (SM), or above the layer of the protocol for controlling quality of service (QOS) flows (e.g., service data adaptation protocol (SDAP)). The data to which the UE and/or the RAN applies the techniques of this disclosure can include, for example, Internet of Things (IoT) data, ethernet traffic data, internet traffic data, or a short message service (SMS) message. Further, as discussed below, the UE 102 in some implementations applies these techniques only if the size of the data is below a certain threshold value.

In the example scenarios discussed below, the UE 102 transitions to the RRC_INACTIVE or RRC_IDLE state, selects a cell of the base station 104, and exchanges data with the base station 104, either via the base station 106 or with the base station 104 directly, without transitioning to RRC_CONNECTED state. As a more specific example, after the UE 102 determines that data is available for uplink transmission in the RRC_INACTIVE or RRC_IDLE state, the UE 102 can apply one or more security functions to the UL data packet, generate a first uplink (UL) protocol data unit (PDU) including the security-protected packet, include a UL RRC message along with the first UL PDU in a second UL PDU, and transmit the second UL PDU to the RAN 105. The UE 102 includes a UE identity/identifier (ID) for the UE 102 in the UL RRC message. The RAN 105 can identify the UE 102 based on the UE ID. In some implementations, the UE ID can be an inactive Radio Network Temporary Identifier (I-RNTI), a resume ID, or a non-access stratum (NAS) ID. The NAS ID can be an S-Temporary Mobile Subscriber Identity (S-TMSI) or a Global Unique Temporary Identifier (GUTI).

The security function can include an integrity protection and/or encryption function. When integrity protection is enabled, the UE 102 can generate a message authentication code for integrity (MAC-I) to protect integrity of the data. Thus, the UE 102 in this case generates a security-protected packet including the data and the MAC-I. When encryption is enabled, the UE 102 can encrypt the data to obtain an encrypted packet, so that the security-protected packet includes encrypted data. When both integrity protection and encryption are enabled, the UE 102 can generate a MAC-I for protecting integrity of the data and encrypt the data along with the MAC-I to generate an encrypted packet and an encrypted MAC-I. The UE 102 then can transmit the security-protected packet to the RAN 105 while in the RRC_INACTIVE or RRC_IDLE state.

In some implementations, the data is a UL service data unit (SDU) of the packet data convergence protocol (PDCP) or SDAP. The UE 102 applies the security function to the SDU and includes the secured SDU in a first UL PDU (e.g., a UL PDCP PDU). The UE 102 then includes the UL PDCP PDU in a second UL PDU such as a UL MAC PDU, which can be associated with the medium access control (MAC) layer. Thus, the UE 102 in these cases transmits the secured UL PDCP PDU in the UL MAC PDU. In some implementations, the UE 102 can include, in the UL MAC PDU, a UL RRC message. In further implementations, the UE 102 may not include a UL RRC message in the UL MAC PDU. In this case, the UE 102 may not include a UE ID of the UE 102 in the UL MAC PDU not including a UL RRC message. In yet further implementations, the UE 102 can include the UL PDCP PDU in a UL radio link control (RLC) PDU and then include the UL RLC PDU in the UL MAC PDU. In the case of including the UL RRC message in the UL MAC PDU, the UE 102 in some implementations generates an RRC MAC-I and includes the RRC MAC-I in the UL RRC message. For example, the RRC MAC-I is a resumeMAC-I field, as specified in 3GPP specification 38.331. In further implementations, the UE can obtain the RRC MAC-I from the UL RRC message with an integrity key (e.g., KRRCint key), an integrity protection algorithm, and other parameters COUNT (e.g., 32-bit, 64-bit or 128-bit value), BEARER (e.g., 5-bit value) and DIRECTION (e.g., 1-bit value).

In further implementations, the data is a UL service data unit (SDU) of the NAS. The UE 102 applies the security function to the SDU and includes the secured SDU in a first UL PDU such as a NAS PDU, which can be associated with the NAS layer. For example, the NAS layer can be an MM sublayer or SM sublayer of 5G, Evolved Packet System (EPS), or 6G. Then the UE 102 can include the UL NAS PDU in a second UL PDU such as a UL RRC message. Thus, the UE 102 in these cases transmits the (first) secured UL NAS PDU in the UL RRC message. In some implementations, the UE 102 can include the UL RRC message in a UL MAC PDU and transmits the UL MAC PDU to a base station (e.g., base station 104 or 106) via a cell (e.g., cell 124 or 126). In this case, the UE 102 may not include an RRC MAC-I in the UL RRC message. Alternatively, the UE 102 may include an RRC MAC-I as described above.

In some implementations, the UL RRC message described above can be a common control channel (CCCH) message, an RRC resume request message, or an RRC early data request message. The UL RRC message can include a UE ID of the UE 102 as described above.

More generally, the UE 102 can secure the data using at least one of encryption and integrity protection, include the secured data as a security-protected packet in the first UL PDU, and transmit the first UL PDU to the RAN 105 in the second UL PDU.

In some scenarios and implementations, the base station 106 can retrieve the UE ID of the UE 102 from the UL RRC message and identify the base station 104 as the destination of the data in the first UL PDU, based on the determined UE ID. In one example implementation, the base station 106 retrieves the first UL PDU from the second UL PDU and transmits the first UL PDU to the base station 104. The base station 104 then retrieves the security-protected packet from the first UL PDU, applies one or two security functions to decrypt the data and/or check the integrity protection, and transmits the data to the CN 110 (e.g., SGW 112, UPF 162, MME 114 or AMF 164) or an edge server. In some implementations, the edge server can operate within the RAN 105. More specifically, the base station 104 derives at least one security key from UE context information of the UE 102.

Then the base station 104 retrieves the data from the security-protected packet by using the at least one security key and transmits the data to the CN 110 or edge server. When the security-protected packet is an encrypted packet, the base station 104 decrypts the encrypted packet to obtain the data by using the at least one security key (e.g., an encryption and/or decryption key). If the security-protected packet is an integrity-protected packet, the integrity-protected packet may include the data and the MAC-I. The base station 104 can verify whether the MAC-I is valid for the security-protected packet by using the at least one security key (e.g., an integrity key). When the base station 104 confirms that the MAC-I is valid, the base station 104 sends the data to the CN 110 or edge server. However, when the base station 104 determines that the MAC-I is invalid, the base station 104 discards the security-protected packet. Further, if the security-protected packet is both encrypted and integrity-protected, the encrypted and integrity-protected packet may include the encrypted packet along with the encrypted MAC-I. The base station 104 in this case decrypts the encrypted packet and the encrypted MAC-I to obtain the data and the MAC-I. The base station 104 then determines whether the MAC-I is valid for the data. If the base station 104 determines that the MAC-I is valid, the base station 104 retrieves the data and forwards the data to the CN 110 or edge server. However, if the base station 104 determines that the MAC-I is invalid, the base station 104 discards the packet.

In another implementation, the base station 106 retrieves the security-protected packet from the first UL PDU. The base station 106 performs a retrieve UE context procedure with the base station 104 to obtain UE context information of the UE 102 from the base station 104. The base station 106 derives at least one security key from the UE context information. Then the base station 106 retrieves the data from the security-protected packet by using the at least one security key and transmits the data to the CN 110 (e.g., UPF 162) or an edge server. When the security-protected packet is an encrypted packet, the base station 106 decrypts the encrypted packet to obtain the data by using the at least one security key (e.g., an encryption and/or decryption key). If the security-protected packet is an integrity-protected packet, the integrity protected packet may include the data and the MAC-I. The base station 106 can verify whether the MAC-I is valid for the security-protected packet by using the at least one security key (e.g., an integrity key). When the base station 106 confirms that the MAC-I is valid, the base station 106 sends the data to the CN 110. On the other hand, when the base station 106 determines that the MAC-I is invalid, the base station 106 discards the security-protected packet. Further, if the security-protected packet is both encrypted and integrity-protected, the encrypted and integrity-protected packet may include the encrypted packet along with the encrypted MAC-I. The base station 106 in this case decrypts the encrypted packet and the encrypted MAC-I to obtain the data and the MAC-I. The base station 106 then determines whether the MAC-I is valid for the data. If the base station 106 determines that the MAC-I is valid, the base station 106 retrieves the data and forwards the data to the CN 110. However, if the base station 106 determines that the MAC-I is invalid, the base station 106 discards the packet.

In other scenarios and implementations, the base station 104 can retrieve the UE ID of the UE 102 from the UL RRC message and identify that the base station 104 stores UE context information of the UE 102. Thus, the base station 104 retrieves the security-protected packet from the first UL PDU, retrieves the data from the security-protected packet, and sends the data to the CN 110 or edge server as described above.

Further, the RAN 105 in some cases transmits data in the downlink (DL) direction to the UE 102 operating in the RRC_INACTIVE or RRC_IDLE state.

For example, when the base station 104 determines that data is available for downlink transmission to the UE 102 currently operating in the RRC_INACTIVE or RRC_IDLE state, the base station 104 can apply at least one security function to the data to generate a security-protected packet, generate a first DL PDU including the security-protected packet, and the first DL PDU in a second DL PDU. To secure the data, the base station 104 can apply the security function (e.g., integrity protection and/or encryption) to the data. More particularly, when integrity protection is enabled, the base station 104 generates a MAC-I for protecting integrity of the data, so that the security-protected packet includes the data and the MAC-I. When encryption is enabled, the base station 104 encrypts the data to generate an encrypted packet, so that the security-protected packet is an encrypted packet. Further, when both integrity protection and encryption are enabled, the base station 104 can generate a MAC-I for protecting the integrity of the data and encrypt the data along with the MAC-I to generate an encrypted packet and an encrypted MAC-I. The base station 104 in some implementations generates a first DL PDU, such as a DL PDCP PDU, using the security-protected packet, includes the first DL PDU in a second DL PDU associated with the MAC layer for example (e.g., a DL MAC PDU), and transmits the second DL PDU to the UE 102 without first causing the UE 102 to transition from the RRC_INACTIVE or RRC_IDLE state to the RRC_CONNECTED state. In some implementations, the base station 104 includes the DL PDCP PDU in a DL RLC PDU, includes the DL RLC PDU in the DL MAC PDU and transmits the DL MAC PDU to the UE 102 without first causing the UE 102 to transition from the RRC_INACTIVE or RRC_IDLE state to the RRC_CONNECTED state.

In another implementation, the base station 104 transmits the first DL PDU to the base station 106, which then generates a second PDU (e.g., a DL MAC PDU) including the first DL PDU and transmits the second DL PDU to the UE 102 without first causing the UE 102 to transition from the RRC_INACTIVE or RRC_IDLE state to the RRC_CONNECTED state. In some implementations, the base station 106 generates a DL RLC PDU including the first DL PDU and includes the DL RLC PDU in the second DL PDU. In yet another implementation, the base station 104 includes the first DL PDU in a DL RLC PDU and transmits the DL RLC PDU to the base station 106, which then generates a second DL PDU (e.g., a DL MAC PDU), including the DL RLC PDU, and transmits the second DL PDU to the UE 102.

In some implementations, the base station (i.e., the base station 104 or 106) generates a downlink control information (DCI) and a cyclic redundancy check (CRC) scrambled with an ID of the UE 102 to transmit the second DL PDU generated by the base station. In some implementations, the ID of the UE 102 can be a Radio Network Temporary Identifier (RNTI). For example, the RNTI can be a cell RNTI (C-RNTI), a temporary C-RNTI or an inactive C-RNTI. The base station transmits the DCI and scrambled CRC on a physical downlink control channel (PDCCH) to the UE 102 operating in the RRC_INACTIVE or RRC_IDLE state. The base station scrambles the CRC with the ID of the UE 102. In some implementations, the base station may assign the ID of the UE 102 to the UE 102 in a random access response that the base station transmits in a random access procedure with the UE 102 before transmitting the DCI and scrambled CRC. In further implementations, the base station may assign the ID of the UE 102 to the UE 102 in an RRC message (e.g., RRC release message or an RRC reconfiguration message) that the base station transmits to the UE 102 before transmitting the DCI and scrambled CRC, e.g., while the UE 102 was in the RRC_CONNECTED state.

The UE 102 operating in the RRC_INACTIVE or RRC_IDLE state can receive the DCI and scrambled CRC on the PDCCH. Then the UE 102 confirms that a physical downlink shared channel (PDSCH), including the second DL PDU, is addressed to the UE 102 according to the ID of the UE 102, DCI, and scrambled CRC. The UE 102 then can retrieve the data from the security-protected packet. If the security-protected packet is an encrypted packet, the UE 102 can decrypt the encrypted packet using the appropriate decryption function and the security key to obtain the data. If the security-protected packet is the integrity-protected packet including the data and the MAC-I, the UE 102 can determine whether the MAC-I is valid. If the UE 102 confirms that the MAC-I is valid, the UE 102 retrieves the data. If, however, the UE 102 determines that the MAC-I is invalid, the UE 102 discards the packet. Finally, when the security-protected packet is both encrypted and integrity-protected, with encrypted data and an encrypted MAC-I, the UE 102 can decrypt the encrypted packet and encrypted MAC-I to obtain the data and the MAC-I. The UE 102 can then verify that the MAC-I is valid for the data. If the UE 102 confirms that the MAC-I is valid, the UE 102 retrieves and processes the data. Otherwise, when the UE 102 determines that the MAC-I is invalid, the UE 102 discards the data.

The base station 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 in an example implementation includes a Medium Access Control (MAC) controller 132 configured to perform a random access procedure with one or more user devices, receive uplink MAC protocol data units (PDUs) to one or more user devices, and transmit downlink MAC PDUs to one or more user devices. The processing hardware 130 can also include a Packet Data Convergence Protocol (PDCP) controller 134 configured to transmit DL PDCP PDUs in accordance with which the base station 104 can transmit data in the downlink direction, in some scenarios, and receive UL PDCP PDUs in accordance with which the base station 104 can receive data in the uplink direction, in other scenarios. The processing hardware further can include an RRC controller 136 to implement procedures and messaging at the RRC sublayer of the protocol communication stack. The processing hardware 130 in an example implementation includes an RRC inactive controller 138 configured to manage uplink and/or downlink communications with one or more UEs operating in the RRC_INACTIVE or RRC_IDLE state. The base station 106 can include generally similar components. In particular, components 140, 142, 144, 146, and 148 of the base station 106 can be similar to the components 130, 132, 134, 136, and 138, respectively.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes an RRC inactive controller 158 configured to manage uplink and/or downlink communications when the UE 102 operates in the RRC_INACTIVE state. The processing hardware 150 in an example implementation includes a Medium Access Control (MAC) controller 152 configured to perform a random access procedure with a base station, transmit uplink MAC protocol data units (PDUs) to the base station, and receive downlink MAC PDUs from the base station. The processing hardware 150 can also include a PDCP controller 154 configured to, in some scenarios, transmit DL PDCP PDUs in accordance with which the base station 106 can transmit data in the downlink direction, and, in further scenarios, receive UL PDCP PDUs in accordance with which the base station 106 can receive data in the uplink direction. The processing hardware further can include an RRC controller 156 to implement procedures and messaging at the RRC sublayer of the protocol communication stack.

FIG. 1B depicts an example distributed or disaggregated implementation of any one or more of the base stations 104, 106. In this implementation, the base station 104, 106 includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include a PDCP controller, an RRC controller and/or an RRC inactive controller such as PDCP controller 134, 144, RRC controller 136, 146 and/or RRC inactive controller 138, 148. In some implementations, the CU 172 can include a radio link control (RLC) controller configured to manage or control one or more RLC operations or procedures. In further implementations, the CU 172 does not include an RLC controller.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a MAC controller (e.g., MAC controller 132, 142) configured to manage or control one or more MAC operations or procedures (e.g., a random access procedure), and/or an RLC controller configured to manage or control one or more RLC operations or procedures. The process hardware can also include a physical layer controller configured to manage or control one or more physical layer operations or procedures.

In some embodiments, the RAN 105 supports Integrated Access and Backhaul (IAB) functionality. In some implementations, the DU 174 operates as an (IAB)-node, and the CU 172 operates as an IAB-donor.

In some implementations, the CU 172 can include a logical node CU-CP 172A that hosts the control plane part of the PDCP protocol of the CU 172. The CU 172 can also include logical node(s) CU-UP 172B that hosts the user plane part of the PDCP protocol and/or Service Data Adaptation Protocol (SDAP) protocol of the CU 172. The CU-CP 172A can transmit control information (e.g., RRC messages, F1 application protocol messages), and the CU-UP 172B can transmit the data packets (e.g., SDAP PDUs or Internet Protocol packets).

The CU-CP 172A can be connected to multiple CU-UP 172B through the E1 interface. The CU-CP 172A selects the appropriate CU-UP 172B for the requested services for the UE 102. In some implementations, a single CU-UP 172B can connect to multiple CU-CP 172A through the E1 interface. The CU-CP 172A can connect to one or more DU 174s through an F1-C interface. The CU-UP 172B can connect to one or more DU 174 through the F1-U interface under the control of the same CU-CP 172A. In some implementations, one DU 174 can connect to multiple CU-UP 172B under the control of the same CU-CP 172A. In such implementations, the connectivity between a CU-UP 172B and a DU 174 is established by the CU-CP 172A using Bearer Context Management functions.

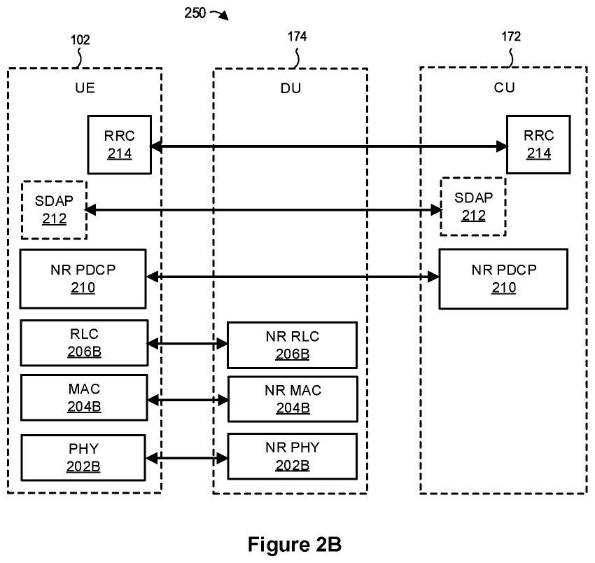

FIG. 2A illustrates, in a simplified manner, an example protocol stack 200 according to which the UE 102 can communicate with an eNB/ng-eNB or a gNB (e.g., one or more of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to an EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2A). The UE 102, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or RRC sublayer (not shown in FIG. 2A) to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 can be SDAP PDUs, Internet Protocol (IP) packets or Ethernet packets.

FIG. 2B illustrates, in a simplified manner, an example protocol stack 250 which the UE 102 can communicate with a DU (e.g., DU 174) and a CU (e.g., CU 172). The radio protocol stack 200 is functionally split as shown by the radio protocol stack 250 in FIG. 2B. The CU at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

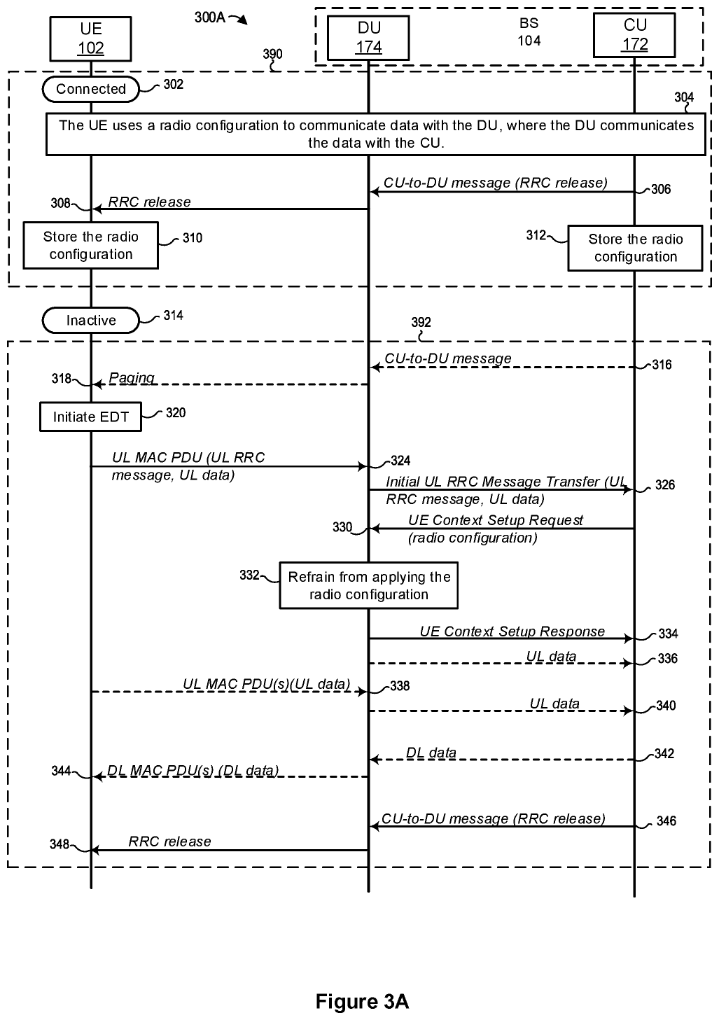

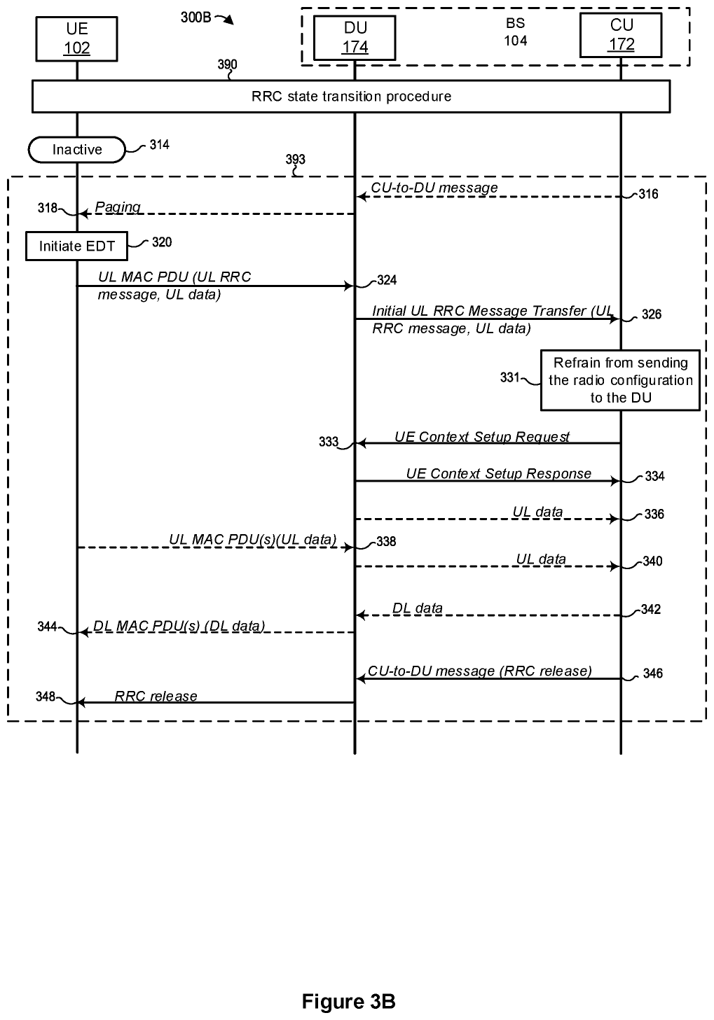

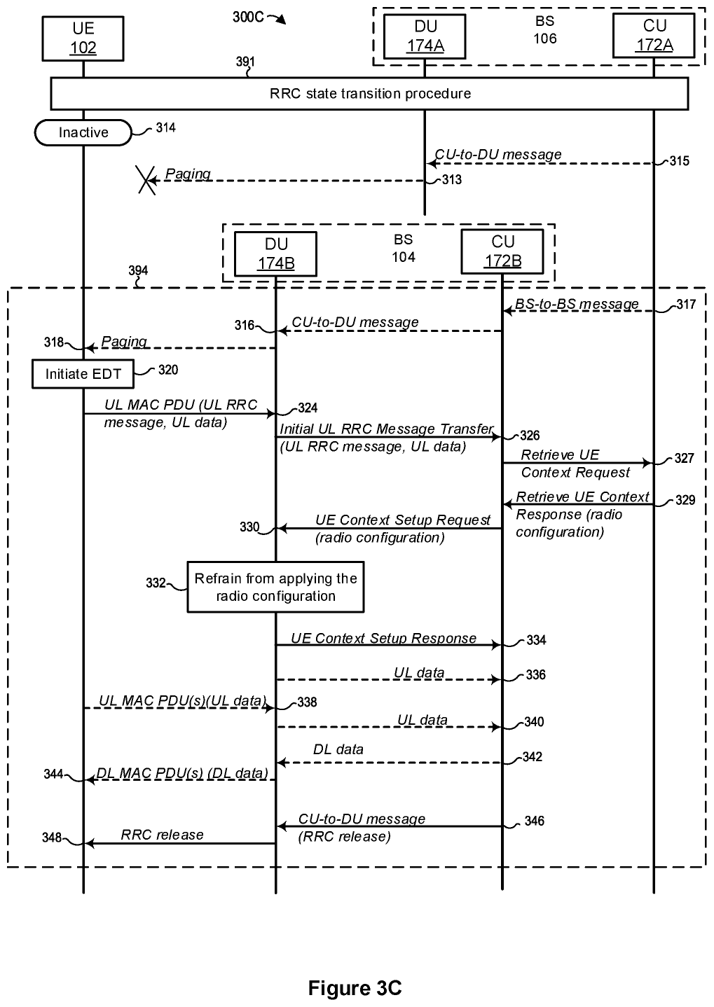

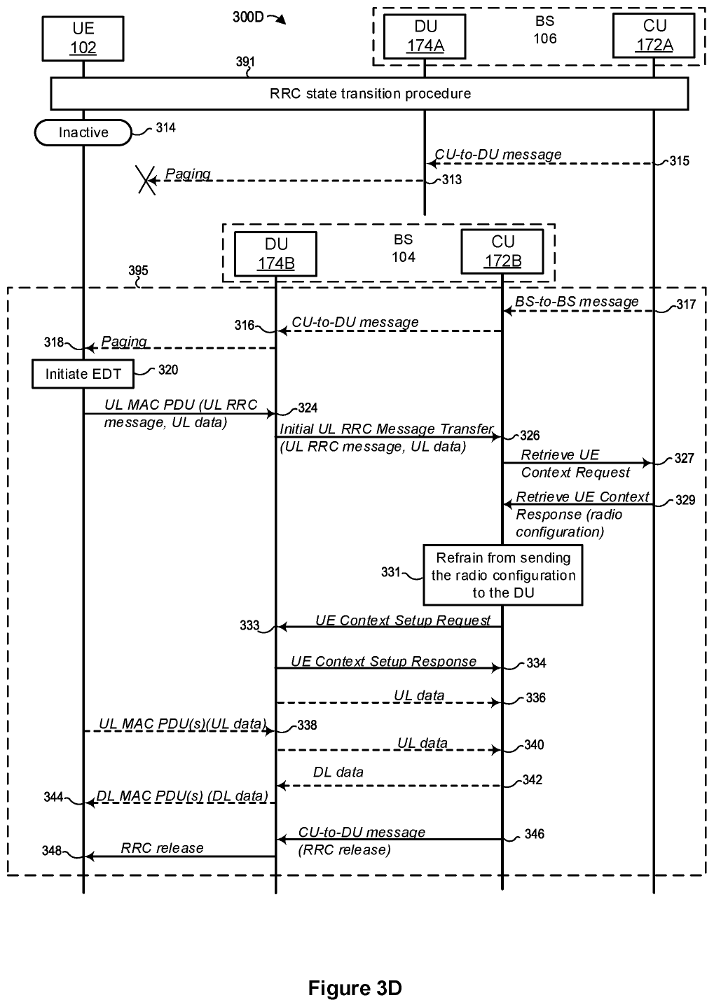

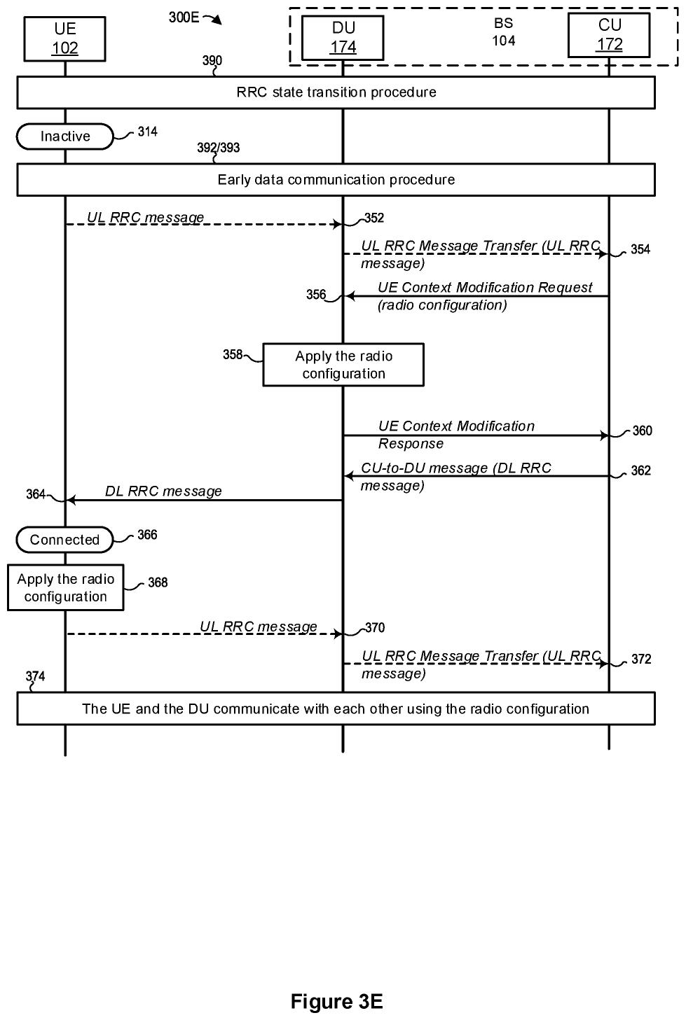

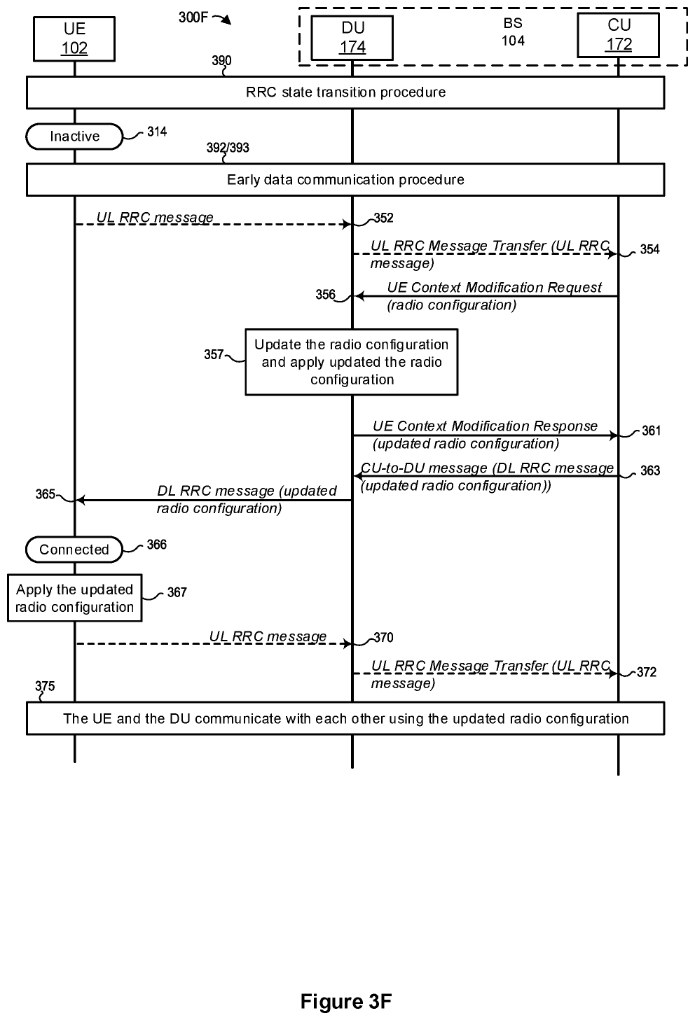

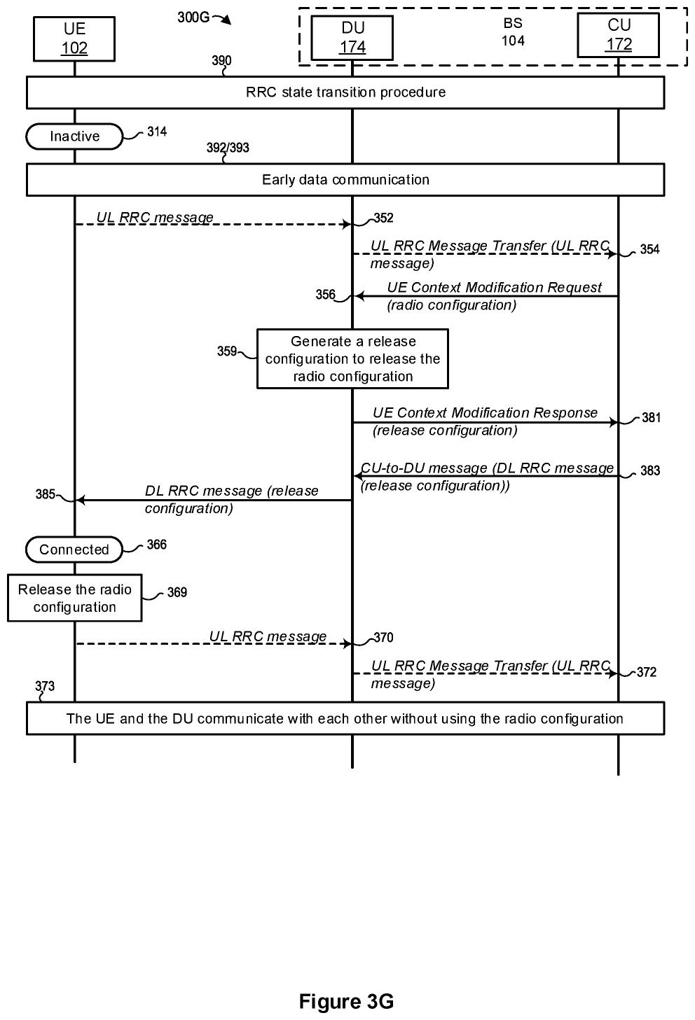

Next, several example scenarios that involve components of FIGS. 1A-1B and relate to transmitting and/or receiving data in an inactive state, idle state, or connected state are discussed with reference to FIGS. 3A-3G. Generally speaking, events in FIGS. 3A-3G that are the same are labeled with the same reference numbers, with differences discussed below where appropriate. To simplify the following description, the “inactive state” can represent the RRC_INACTIVE or RRC_IDLE state, and the connected state can represent the RRC_CONNECTED state.

FIGS. 3A-3B illustrate alternative mechanisms by which either a DU or a CU of a distributed base station can manage whether the DU enables a radio function to communicate with a UE.

Referring first to FIG. 3A, in a scenario 300A, the UE 102 initially operates 302 in a connected state with the base station 104 including a CU 172 and a DU 174. While the UE 102 operates in the connected state, the UE 102 uses 304 a radio configuration to communicate data with the DU 174, where the DU 174 communicates 304 the data with the CU 172. In some scenarios and implementations, the UE 102 in the connected state communicates 304 data with the CU 172 and the DU 174, e.g., via one or more radio bearers (RBs). The UE 102 in the connected state communicates the control-plane (CP) data via one or more signaling RBs (SRBs). The UE 102 in the connected state communicates the user-plane (UP) data via one or more data RBs (DRBs). Before or during the event 304, the CU 172 may perform a UE Context procedure (e.g., a UE Context Setup procedure or a UE Context Modification procedure) with the DU 174 to obtain the radio configuration. In some implementations, the CU 172 receives the radio configuration from a source base station 106 during a handover procedure.

The CU 172 can determine that neither the CU 172 nor the UE 102 has transmitted any data in the downlink direction or the uplink direction, respectively, during a (first) certain period. In some implementations (not shown), the DU 174 can send to the CU 172 a DU-to-CU message (not shown in FIG. 3A) indicating data inactivity with the UE 102 over the (first) certain period. Thus, the CU 172 can determine the data inactivity for the UE 102 by taking into account the explicit data inactivity indication from the DU 174. In response to the determination, the CU 172 can determine to transition the UE 102 from the connected state to an inactive state.

In response to determining to transition the UE 102 to the inactive state, the CU 172 transmits 306 to the DU 174 a first CU-to-DU message, which includes a first RRC release message (e.g., an RRCRelease message) instructing the UE 102 to transition to the inactive state. The DU 174 retrieves the first RRC release message from the first CU-to-DU message and sends 308 the first RRC release message to the UE 102. The UE 102 transitions 314 to the inactive state upon receiving the first RRC release message. The CU 172 can assign an/-RNTI or a resume ID to the UE 102 and include the assigned value in the first RRC release message. In some embodiments, after the UE 102 transitions 314 to the inactive state, the UE 102 may perform one or more RAN notification area (RNA) updates with the CU 172 via the DU 174 without state transitions.

Further, in response to the first RRC release message or while the UE 102 operates in the inactive state, the UE 102 stores 310 (i.e., refrains from releasing) and stops applying the radio configuration. The CU 172 also stores 312 (i.e., refrains from releasing) the radio configuration for the UE 102 operating in the inactive state. In some implementations, the DU 174 stops applying the radio configuration for the UE 102 in response to receiving 306 the first CU-to-DU message. In other implementations, the UE 102 can send (not shown) an acknowledgement to the DU 174 to acknowledge reception of a PDU including the first RRC release message. In such implementations, the DU 174 stops applying the radio configuration for the UE 102 in response to receiving the acknowledgement. In some implementations, the PDU can be a MAC PDU and the acknowledgement can be a HARQ acknowledgement. In other implementations, the PDU can be an RLC PDU and the acknowledgement can be an RLC acknowledgement.

The events 302, 304, 306, 308, 310, and 312 are collectively referred to in FIG. 3A as an RRC state transition procedure 390.

At a later time, the UE 102 in the inactive state initiates 320 EDT to transmit UL data or receive DL data. In some cases, the UE 102 initiates EDT in order to transmit at least one UL data packet to the base station 104 (i.e., mobile originating (MO) EDT). In such cases, the UE 102 detects an UL data packet for transmission to the base station 104, and initiates EDT to transmit the UL data packet if the UL data packet is suitable for EDT (e.g., if the UL data packet size is below a maximum size for EDT, or if the UL data meets other criteria, as described below). In other cases, the UE 102 initiates EDT to receive at least one DL data packet from the base station 104 (i.e., mobile terminating (MT) EDT), which can also be described as early data reception from the perspective of the UE 102). In such cases, the CU 172 detects DL data for the UE 102 that is suitable for transmission using EDT and, in response, transmits 316 a CU-to-DU message to the DU 174 in order to page the UE 102. The DU transmits 318 a Paging message, which may include a UE ID of the UE 102 and an EDT indication, to the UE 102. The UE ID may be the I-RNTI or the resume ID. The EDT indication notifies the UE 102 to initiate EDT in order to receive the DL data without transitioning to the connected state. The UE 102 can then initiate EDT in response to receiving 318 the Paging message (i.e., in response to receiving the UE ID and the EDT indication).

The (UL/DL) data in some example scenarios is an Internet Protocol (IP) packet, an Ethernet packet, or an application packet. In other scenarios, the data is a PDU (e.g., SDAP PDU, RRC PDU, PDCP PDU, RLC PDU or MAC PDU) that includes an RRC message, an NAS message, an IP packet, an Ethernet packet, or an application packet. Still further, the data in some scenarios can be an RRC PDU including an NAS PDU, such that the NAS PDU includes an IP packet, an Ethernet packet, or an application packet. In some implementations, the UE 102 can determine whether the UL data qualifies for transmission in the inactive state in view of one or more factors such as whether the data is an IMS packet; whether the data is associated with a radio bearer (e.g., DRB or SRB) not suitable or configured for early data transmission; or whether the data is a NAS message for initiating a particular NAS procedure, the size of the data, etc. When the UE 102 determines that the UL data does not qualify for transmission in the inactive state, the UE 102 can perform an RRC procedure (e.g., RRC connection establishment procedure or RRC resume procedure) to transition to the connected state. In some implementations, the CU 172 can determine whether the DL data qualifies for transmission in the inactive state in view of one or more of such factors as whether the data is an IMS packet; whether the data is associated with a radio bearer (e.g., DRB or SRB) not suitable or configured for early data transmission; or whether the data is an NAS message for initiating a particular NAS procedure, the size of the data, etc.

In response to or after initiating 320 EDT, the UE 102 generates an initial UL MAC PDU, which includes a UL RRC message and transmits 324 the initial UL MAC PDU to the DU 174 on the cell 124. The DU 174 retrieves the UL RRC message from the initial UL MAC PDU, generates an Initial UL RRC Message Transfer message including the UL RRC message, and sends 326 the Initial UL RRC Message Transfer message to the CU 172.

In scenarios in which the UE 102 initiates EDT to transmit UL data, the UE 102 includes UL data (e.g., a data packet) in the initial UL MAC PDU that the UE 102 transmits 324, as shown in FIG. 3A. In scenarios in which the UE 102 initiates EDT to receive DL data, the UE 102 does not include an UL data packet in the UL MAC PDU that the UE 102 transmits 324. In such scenarios, the UE 102 can include an EDT indication in the initial UL MAC PDU or the UL RRC message to indicate to the base station 104 that the UE 102 is initiating EDT to receive DL data.

In some implementations, the UE 102 in the inactive state performs a random access procedure with the DU 174 to initiate 320 EDT. For example, the random access procedure can be a four-step random access procedure or a two-step random access procedure. In the case of a four-step random access procedure, the UE 102 transmits a random access preamble to the base station 104 and, in response, the base station 104 transmits to the UE 102 a random access response (RAR) including an uplink grant, and the UE 102 transmits 324 the UL MAC PDU in accordance with the uplink grant. The DU 174 receives 324 the UL MAC PDU in accordance with the uplink grant in the RAR. In the case of a two-step random access procedure, the UE 102 transmits 324, to the DU 174, a message A including a random access preamble and the UL MAC PDU in accordance with two-step random access configuration parameters. The UE 102 can receive the two-step random access configuration parameters in system information broadcast by the DU 174 on the cell 124 before transmitting 324 the UL MAC PDU. The DU 174 receives 324 the UL MAC PDU in accordance with the two-step random access configuration parameters. In other implementations, the UE 102 transmits 324 the UL MAC PDU on radio resources configured in a preconfigured uplink resources (PUR) configuration or a configured grant (CG) configuration. The CU 172 can obtain the PUR configuration or the CG configuration from the DU 174 and include the PUR configuration or CG configuration in the first RRC release message that the CU 172 transmits 306. Thus, the DU 174 receives 324 the UL MAC PDU on the radio resources. In some implementations, the UE 102 can transmit 338 subsequent UL MAC PDU(s), discussed below, on radio resources configured in the PUR configuration or the CG configuration. In cases where the first RRC release message includes other PUR configuration(s) or CG configuration(s), the UE 102 can transmit 338 the UL MAC PDU(s) on radio resources configured in the other PUR configuration(s) or CG configuration(s).

If the UE 102 includes UL data in the initial UL MAC PDU, the DU 174 retrieves the UL data from the initial UL MAC PDU. In such cases, the DU 174 can include the UL data in the Initial UL RRC Message Transfer message that the DU transmits 326. Alternatively, the DU 174 can send the UL data to the CU 172 separately, via a user-plane (UP) connection as described below. After receiving 326 the Initial UL RRC Message Transfer message, the CU 172 in some implementations sends 330 to the DU 174 a UE Context Setup Request message including the radio configuration to establish a UE Context of the UE 102 at the DU 174. In response, the DU 174 sends 334 a UE Context Setup Response message to the CU 172. After or in response to receiving the UE Context Setup Request message, the DU 174 refrains 332 from applying the radio configuration. When refraining from applying the radio configuration, the DU 174 refrains from enabling an operation or radio function at the DU 174 corresponding to the radio configuration. The CU 172 performs the UE Context Setup procedure with the DU 174 to set up UL and/or DL tunnels with the DU 174 to exchanging UL and/or DL data.

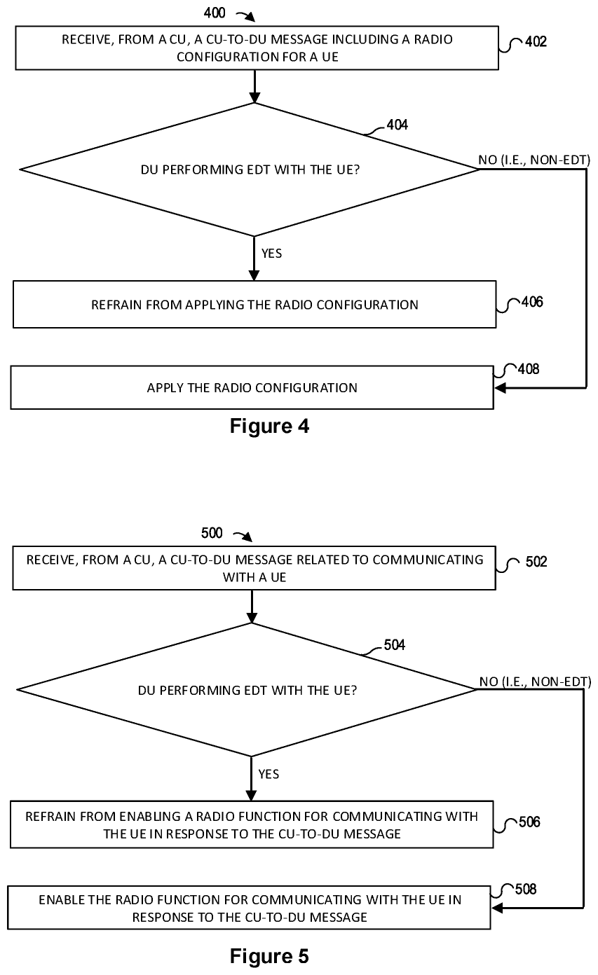

The DU 174 may refrain 332 from applying the radio configuration in response to determining that the DU 174 does not require a radio function corresponding to the radio configuration to communicate with the UE 102. The DU 174 may determine that the DU 174 does not require the radio function if the DU 174 determines that the UE 102 is operating in the inactive state, or determines that the DU 174 is performing EDT with the UE 102. For example, the DU 174 can determine that the DU 174 is performing EDT in response to receiving 330 an EDT indication in the CU-to-DU message. As another example, the DU 174 can determine that the DU 174 is performing EDT based on receiving 324 the UL MAC PDU from the UE including both the UL RRC message and UL data. Example methods that the DU 174 may implement to determine whether to refrain from applying a radio configuration or refrain from enabling a radio function are discussed below with reference to FIGS. 4-7.

In some implementations, the radio configuration is a CellGroupConfig IE. In other implementations, the radio configuration includes at least one configuration parameter in the CellGroupConfig IE. In one example, the at least one configuration parameter includes a DRX configuration (e.g., DRX-Config IE) and/or a measurement gap configuration (e.g., MeasGapConfig IE). In such an example, the DU 174 refrains 332 from enabling a DRX operation and/or a measurement gap operation. As a result, the DU 174 can utilize all DL/UL slots to transmit and/or receive DL/UL data to/from the UE 102, without leaving gaps for DRX cycles or measurement gaps. The EDT session therefore requires less time to complete, resulting in improved power saving for the UE. In another example, the at least one configuration parameter includes channel state information reference signal (CSI-RS) configuration(s) and/or UE-specific reference signal configuration(s). The DU 174 refrains 332 from enabling periodic transmission of the CSI-RS and/or UE-specific reference signal, which saves the DU 174 power and prevents the DU 174 from using radio resources to transmit the reference signals.

In some implementations, the CU 172 includes UL UP Transport Layer Information in the UE Context Setup Request message to establish a UL packet tunnel for receiving the UL data and/or subsequent UL data (e.g., subsequent UL data 340). For example, the UL UP Transport Layer Information can include a Transport Layer Address (e.g., IP address) and a Tunnel Endpoint ID (TEID) (e.g., General Packet Radio Service (GPRS) Tunneling Protocol (GTP) TEID). Thus, in scenarios in which the DU 174 does not include the UL data in the Initial UL RRC Message Transfer message that the DU 174 transmits 324, the DU 174 can generate a first UL tunnel packet including the Transport Layer address, the TEID, and the UL data and send 336 the first UL tunnel packet to the CU 172. In some scenarios and implementations, the UE 102 can send 338 to the DU 174 one or more UL MAC PDUs each including subsequent UL data (e.g., one or more UL data packets and/or a particular segment of a UL data packet). In such scenarios and implementations, the DU 174 can generate one or more second UL tunnel packets each including the Transport Layer address, the TEID, and a particular UL data packet that DU 174 receives at event 338. The DU 174 then sends 340 the one or more second UL tunnel packets to the CU 172.

After receiving 326 the Initial UL RRC Message Transfer message, transmitting 330 the UE Context Setup Request message, or receiving 334 the UE Context Setup Response message, the CU 172 can send 342 DL data (e.g., one or more DL data packets) to the DU 174. In some implementations, the DU 174 can include DL UP Transport Layer Information in the UE Context Setup Response message to establish a DL packet tunnel for receiving 342 the DL data (e.g., one or multiple DL data packets). For example, the DL UP Transport Layer Information can include a Transport Layer Address (e.g., IP address) and a TEID (e.g., GTP TEID). In such scenarios and implementations, the CU 172 can generate one or more DL tunnel packets each including the Transport Layer address, the TEID, and a particular DL data packet, and transmit 342 the one or more DL tunnel packets to the DU 174. In turn, the DU 174 sends 344 to the UE 102 one or more DL MAC PDUs each including one or more DL data packets or a particular segment of a DL data packet that the DU 174 receives from the CU 172.

After a (second) certain period of data inactivity for the UE 102, similar to the determination with respect to the first certain period of data inactivity the CU 172 can determine that neither the CU 172 nor the UE 102 has transmitted any data in the downlink direction or the uplink direction after receiving the Initial UL RRC Message Transfer message, transmitting the UE Context Setup Request message, receiving the UE Context

Setup Response message, receiving 336 UL data or transmitting 342 DL data, during the (second) certain period. In response to the determination, the CU 172 sends 346 a CU-to-DU message including a second RRC release message to the DU 174, and the DU 174 transmits 348 the second RRC release message to the UE 102, similar to events 306 and 308, respectively. The UE 102 remains in the inactive state in response to or after receiving 348 the second RRC release message.

In some implementations, the UL RRC message is an (existing) RRC resume request message (e.g., an RRCResumeRequest message, an RRCResumeRequest1 message, an RRCConnectionResumeRequest message, or an RRCConnectionResumeRequest1 message). In other implementations, the UL RRC message is a new RRC resume request message, similar to the existing RRC resume request message. For example, the new RRC resume request message may be defined in future 3GPP standards documentation. In some implementations, the UL RRC message can include an EDT indication which can be a field or information element (IE) (e.g., resumeCause or ResumeCause). In some implementations, the UL RRC message is a common control channel (CCCH) message.

The events 316, 318, 320, 322, 324, 326, 330, 332, 334, 336, 338, 340, 342, 344, 346, and 348 are collectively referred to in FIG. 3A as an early data communication procedure 392.

Turning next to FIG. 3B, a scenario 300B is initially similar to the scenario 300A. In the scenario 300A, the DU 174 receives a radio configuration from the CU 172, but determines not to enable an operation corresponding to the radio configuration. In contrast, in the scenario 300B, the CU 172 prevents the DU 174 from enabling the operation by refraining from transmitting the radio configuration to the DU 174. In particular, after receiving 326 the Initial UL RRC Message Transfer message, the CU 172 refrains 331 from sending the radio configuration to the DU 174. When the CU 172 transmits 333 a UE Context Setup Request message to the DU 174 to establish a UE Context of the UE 102 at the DU 174, the CU 172 excludes the radio configuration from the message (in contrast to event 330 of FIG. 3A). Because the DU 174 does not receive the radio configuration, the DU 174 does not enable operations corresponding to the radio configuration. In response to receiving 333 the UE Context Setup Request message, the DU 174 transmits 334 a UE Context Setup Response message to the CU 172. The scenario 300B then proceeds similarly to the scenario 300A.

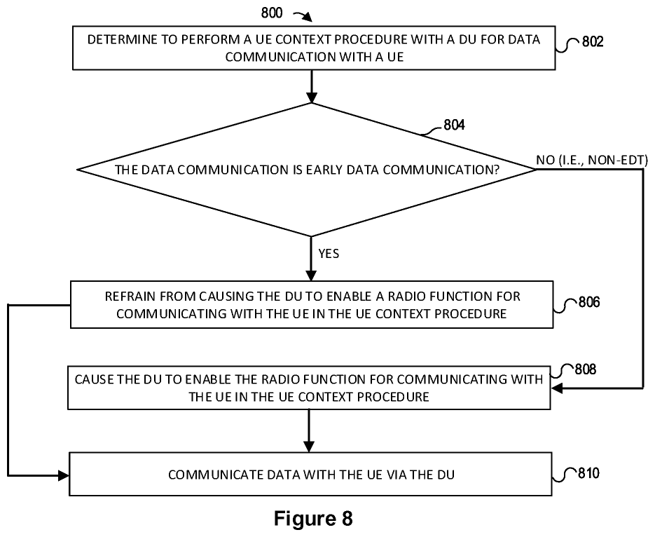

The CU 172 may determine to refrain 331 from sending the radio configuration to the DU 174 in response to determining that the DU 174 does not require a radio function corresponding to the radio configuration to communicate with the UE 102. The CU 172 may determine that the DU 174 does not require the radio function if the CU 172 determines that the UE 102 is operating in the inactive state, or determines that the CU 172 is performing EDT with the UE 102 via the DU 174. Example methods that the CU 172 may implement to determine whether to refrain from sending a radio configuration to the DU 174 or refrain from causing the DU 174 to enable a radio function are discussed below with reference to FIGS. 8-10.

The events 316, 318, 320, 324, 326, 331, 333, 334, 336, 338, 340, 342, 344, 346, and 348 are collectively referred to in FIG. 3B as an early data communication procedure 393.

FIG. 3C and FIG. 3D are example message sequences similar to the message sequences of FIG. 3A and FIG. 3B, respectively, but where the UE 102 changes coverage areas after transitioning 314 to the inactive state. Turning first to FIG. 3C, in a scenario 300C, the UE 102 initially communicates with a base station 106, which includes a CU 172A and a DU 174A. The base station 106 performs an RRC state transition procedure 391, which is similar to the RRC state transition procedure 390, with the UE 102 to cause the UE 102 to transition 314 to the inactive state.

At a later time, the UE 102 moves from a coverage area of the base station 106 (e.g., the cell 126) to a coverage area of the base station 104 (e.g., the cell 124). While in the coverage area of the base station 104, the UE 102 initiates 320 EDT to communicate data with the base station 104 while operating in the inactive state. As discussed above with reference to FIG. 3A, the UE 102 may initiate EDT in response to detecting UL data for the base station 104 (i.e., MO EDT), or in response to receiving 318 a Paging message from the DU 174B of the base station 104 (i.e., MT EDT).

In the case of MT EDT, the source base station 106 may detect DL data for the UE 102. In response, the DU 174 transmits 315 a CU-to-DU message to the DU 174A to cause the DU 174A to transmit 313 a Paging message to the UE 102. However, the Paging message that the DU 174A transmits 313 does not reach the UE 102 due to the changed location of the UE 102. The CU 172A also transmits 317 a BS-to-BS message to the CU 172B to notify the neighboring base station 106 of the DL data available for the UE 102. The CU 172B then pages the UE 102 via the DU 174B.

After receiving 326 an Initial UL RRC Message Transfer message from the DU 174B, the CU 172B transmits 327 a Retrieve UE Context Request message to the CU 172A to retrieve a UE Context of the UE 102. In response, the CU 172A transmits 329, to the CU 172B, a Retrieve UE Context Response message including the radio configuration that the UE 102 previously used to communicate with the base station 106 prior to the RRC state transition procedure 391. The scenario 300C then continues similarly to the scenario 300A, with the DU 174B refraining 332 from applying the radio configuration. The events 317, 316, 318, 320, 324, 326, 327, 329, 330, 332, 334, 336, 338, 340, 342, 344, 346, and 348 are collectively referred to as an early data communication procedure 394.

Turning next to FIG. 3D, a scenario 300D is similar to the scenario 300C, as the UE 102 moves coverage areas after transitioning 314 to the inactive state. However, as in the scenario 300B, the CU 172B refrains 331 from sending the radio configuration (i.e., the radio configuration that the CU 172B receives 329 from the CU 172A) to the DU 174B. The scenario 300D then continues similarly to the scenario 300B. The events 317, 316, 318, 320, 324, 326, 327, 329, 331, 333, 334, 336, 338, 340, 342, 344, 346, and 348 are collectively referred to as an early data communication procedure 395.

FIGS. 3E-3G illustrate scenarios 300E, 300F, and 300G, respectively, each of which may occur after any one of the scenarios 300A-300D. Further, the scenarios 300E-300G include the UE 102 transitioning 366 from the inactive state to the connected state.

Turning first to FIG. 3E, in the scenario 300E, the UE 102 operating 314 in the inactive state performs an early data communication procedure 392 or 393 with the base station 104. At a later time, the UE 102 may request to transition to the connected state (e.g., in response to detecting UL data for the base station 104 that does not qualify for EDT), or the CU 172 may independently determine to transition the UE 102 to the connected state (e.g., in response to detecting DL data for the UE 102 that does not qualify for EDT). If the UE 102 initiates the state transition to the connected state, the UE 102 transmits 352 an UL RRC message to the DU 174, which the DU 174 transmits 354 to the CU 172 in an UL RRC Message Transfer message. The CU 172 can then determine to transition the UE 102 to the connected state in response to the UL RRC Message Transfer message. In other implementations, the CU 172 determines to transition the UE 102 to the connected state without receiving 354 the message from the UE 102 via the DU 174. In some implementations, the UL RRC message can be an RRC resume request message similar to event 324. In other implementations, the UL RRC message can be a (newly-defined) RRC message different from the UL RRC message that the UE 102 transmits at event 324. The UE 102 can transmit the (newly-defined) RRC message on a dedicated control channel (DCCH).

In response to determining to transition the UE 102 to the connected state, the CU 172 transmits 356 a UE Context Modification Request message to the DU 174. In some implementations (as shown in FIG. 3E), the CU 172 includes the radio configuration in the UE Context Modification Request message. The DU 174 then applies 358 the radio configuration in response to receiving 356 the UE Context Modification Request message, and transmits 360 a UE Context Modification Response message to the CU 172. To transition the UE 102 to the connected state, the CU 172 transmits 362 a CU-to-DU message including a DL RRC message (e.g., an RRC resume message, such as an RRCResume message or an RRCConnectionResume message) to the DU 174, which in turn transmits 364 the DL RRC message to the UE 102. In response to receiving 364 the DL RRC message, the UE 102 transitions 366 to the connected state and applies 368 the radio configuration for communicating with the base station 104. In some implementations, the UE 102 transmits 370 an UL RRC message (e.g., an RRC resume complete message, such as an RRCResumeComplete message) to the DU 174 to indicate that the UE 102 successfully transitioned 366 to the connected state. The DU 174 transmits 372 the UL RRC message to the UE 102 in an UL RRC Message Transfer message. The UE 102 can then communicate 374 with the DU using the radio configuration.

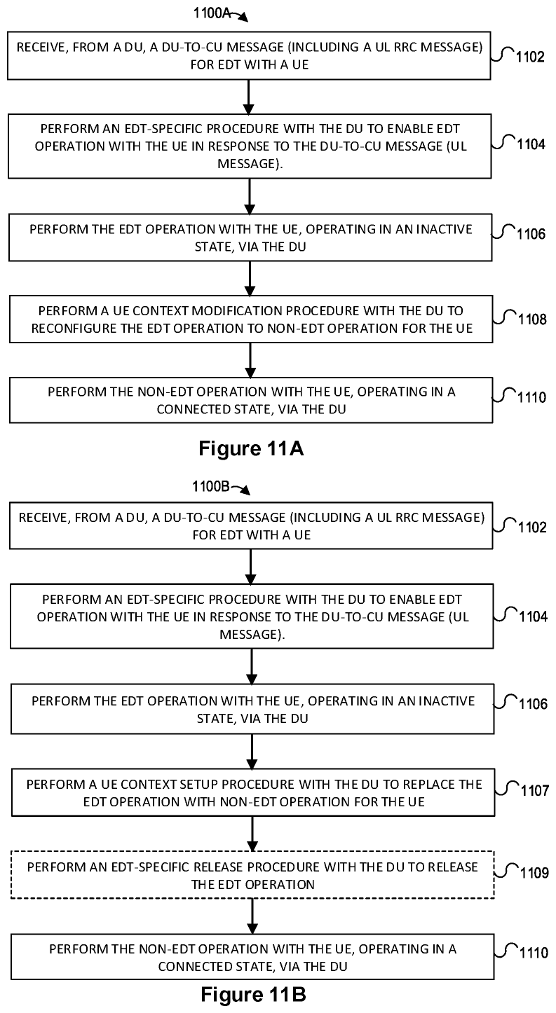

In FIG. 3E, the CU 172 performs a UE Context Modification procedure with the DU 174 to reconfigure the DU 174 and the CU 172 to communicate with the UE 102 when the UE 102 operates in the connected state. UE Context procedures that the CU 172 performs to prepare for transitioning the UE 102 to the connected state are further discussed below with reference to FIGS. 11A-11B.

Turning to FIG. 3F, the scenario 300F is similar to the scenario 300E, except that the DU 174 updates 357 the radio configuration in response to receiving 356 the UE Context Modification Request message from the CU 172. The DU 174 applies 357 the updated radio configuration, and transmits 361 a UE Context Modification Response message including the updated radio configuration to the CU 172. The events 363, 365, and 367 are similar to the events 362, 364, and 368, except that the DL RRC message that the CU 172 transmits 363 to the DU 174 includes the updated radio configuration, and the UE 102 applies 367 the updated radio configuration. After transitioning 366 to the connected state, the UE 102 and the DU 174 communicate 375 with each other using the updated radio configuration.

Turning to FIG. 3G, the scenario 300G is similar to the scenario 300F, except that the DU 174 generates 359 a release configuration to release the radio configuration in response to receiving 356 the UE Context Modification Request. Accordingly, events 381, 383, and 385 are similar to events 361, 363, and 365, except that the updated radio configuration is replaced by a release configuration. In response to receiving 385 the DL RRC message including the release configuration, the UE 102 transitions 366 to the connected state and releases 369 the radio configuration. The UE 102 and the DU 174 then communicate 373 with each other without using the radio configuration.

FIGS. 4-13 are flow diagrams depicting example methods that a network node of a RAN (e.g., a network node of the RAN 105, such as the DU 174, the CU 172, or the base station 104) can implement to manage enabled radio functions for communicating with a UE (e.g., the UE 102). As indicated at various points throughout the disclosure, the example methods depicted in FIGS. 4-13 may be implemented during the scenarios 300A-300G described above.

FIGS. 4-7 illustrate example methods that may be implemented by a DU (e.g., the DU 174) to determine whether to enable a radio function at the DU. The DU may perform the methods illustrated by FIGS. 4-7 during the early data communication procedures 392, 394 (e.g., when determining to refrain 332 from applying the radio configuration), and/or during the scenario 300E (e.g., when determining to apply 358 the radio configuration).

Turning first to FIG. 4, a DU can implement a method 400 to determine whether to apply a radio configuration based on whether the DU is performing early data communication. At block 402, the DU receives, from a CU (e.g., the CU 172), a CU-to-DU message including a radio configuration for a UE (e.g., the UE 102) (e.g., events 330, 356). At block 404, the DU determines whether the DU is performing EDT with the UE. For example, the DU can determine that the DU is performing EDT in response to receiving an EDT indication in the CU-to-DU message. As another example, the DU can determine that the DU is performing EDT based on receiving an UL MAC PDU from the UE including both an UL RRC message and UL data (e.g., event 324). If the DU is performing EDT with the UE, then the DU refrains from applying the radio configuration at block 406 (e.g., event 332). Otherwise, the DU applies the radio configuration at block 408 (e.g., event 358). In some implementations, at block 408, the DU can update the radio configuration and apply the updated radio configuration (e.g., event 357 of FIG. 3F).

FIG. 5 is a flow diagram of a method 500, which is similar to the method 400, with some differences depending on the implementation. At block 502, the DU receives, from a CU, a CU-to-DU message related to communicating with a UE (e.g., events 330, 333, 356). The CU-to-DU message may include a radio configuration, similar to block 402, or may not include a radio configuration. At block 504, the DU determines whether the DU is performing EDT with the UE, similar to block 404. If the DU determines that the DU is performing EDT with the UE, then the DU at block 506 refrains from enabling a radio function for communicating with the UE, in response to the CU-to-DU message. For example, if the CU-to-DU message includes a radio configuration having configuration parameters corresponding to the radio function, the DU can refrain from enabling the radio function by refraining from applying the radio configuration, similar to block 406 (e.g., event 332). As another example, if the CU-to-DU message does not include a radio configuration (e.g., event 333), the DU can refrain from enabling a radio function that is not required for EDT. For instance, the DU can refrain from enabling a radio function that the DU uses to communicate with a UE operating in a connected state. If the DU determines that the DU is not performing EDT with the UE, then the DU, at block 508, enables the radio function for communicating with the UE, in response to the CU-to-DU message. For example, if the CU-to-DU message includes a radio configuration, then the DU enables the radio function by applying the radio configuration, similar to block 408 (e.g., event 358, 357).

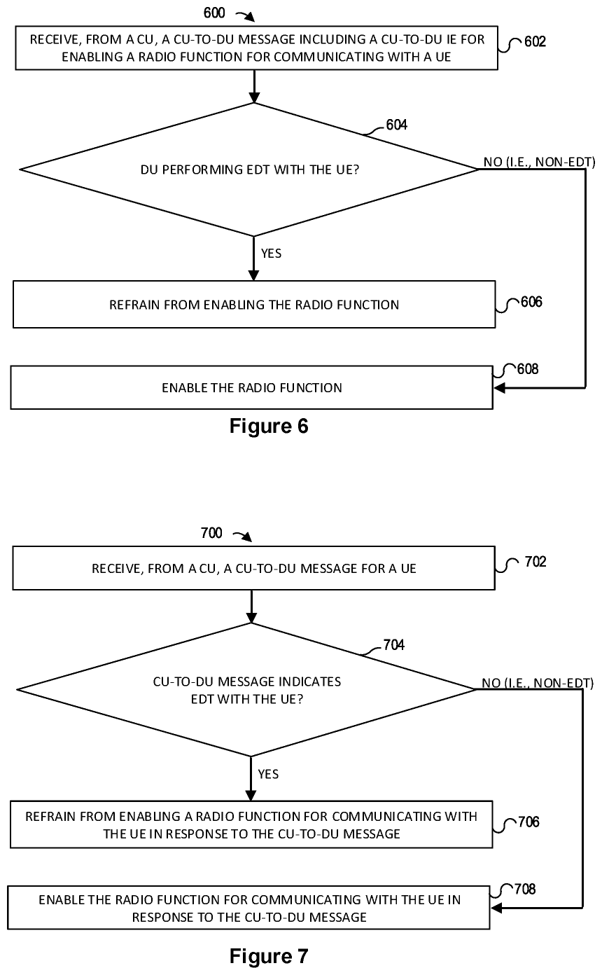

FIG. 6 is a flow diagram of a method 600, which may augment the methods 400 and/or 500. At block 602, the DU receives, from a CU, a CU-to-DU message including a CU-to-DU IE for enabling, or related to, a radio function for communicating with a UE (e.g., events 330, 333, 356). The CU-to-DU IE may be a F1AP, W1AP IE, or an RRC IE. In some implementations, the CU-to-DU IE is a DRX Cycle IE or DRX-Config IE, and the corresponding radio function is a DRX operation that the DU performs. In other implementations, the CU-to-DU IE is a MeasConfig IE, and the corresponding radio function may be a measurement gap operation configured by the MeasConfig IE, or a transmission of a reference signal (e.g., a CSI-RS or UE-specific reference signal) configured by the MeasConfig IE. At block 604, the DU determines whether the DU is performing EDT with the UE, similar to block 404. If so, then the DU refrains from enabling the radio function at the DU, at block 606 (e.g., event 332). Otherwise, the DU enables the radio function at the DU, at block 608 (e.g., event 358, 357).

FIG. 7 is a flow diagram of a method 700, which may augment the methods 400, 500, and/or 600. At block 702, the DU receives, from a CU, a CU-to-DU message for a UE (e.g., events 330, 333, 356). At block 704, the DU determines whether the CU-to-DU message indicates EDT (e.g., indicates that the DU is to perform EDT with the UE or indicates that the DU is performing EDT with the UE). In some implementations, to indicate EDT, the CU-to-DU message includes an IE (e.g., an EDT indication), or includes a configuration related to EDT (e.g., an EDT configuration including configuration parameters for performing EDT). If the CU-to-DU message indicates EDT, then at block 706 the DU refrains from enabling a radio function for communicating with the UE, in response to the CU-to-DU message, similar to blocks 506 and 606 (e.g., event 332). Otherwise, at block 708, the DU enables the radio function, in response to the CU-to-DU message, similar to blocks 508 and 608 (e.g., event 358, 357).

FIGS. 8-10 illustrate example methods that may be implemented by a CU (e.g., the CU 172) to determine whether to enable a radio function at a DU. The CU may perform the methods illustrated by FIGS. 8-10 during the early data communication procedures 393, 395 (e.g., when determining to refrain 331 from sending the radio configuration to the DU), and/or during the scenario 300E (e.g., when determining to transmit 356 the radio configuration to the DU).

Turning first to FIG. 8, a CU can implement a method 800 to determine whether to cause a DU to enable a radio function for communicating with a UE based on whether the CU is performing early data communication with a UE. At block 802, the CU determines to perform a UE Context procedure with a DU for data communication with a UE (e.g., a UE Context Setup procedure or a UE Context Modification procedure). At block 804, the CU determines whether the data communication is early data communication. If so, then at block 806, the CU refrains from causing, in the UE Context procedure, the DU to enable a radio function for communicating with the UE (e.g., by refraining from transmitting a radio configuration to the DU in a CU-to-DU message during the UE Context procedure, such as at event 331, or by excluding an EDT indication or EDT configuration from the CU-to-DU message, as discussed with reference to block 704). Otherwise, at block 808, the CU causes, in the UE Context procedure, the DU to enable the radio function for communicating with the UE (e.g., by including a radio configuration in a CU-to-DU message during the UE Context procedure, such as at event 356, or by including an EDT indication or EDT configuration in the CU-to-DU message, as discussed with reference to block 704). After performing the UE Context procedure with the DU, the CU communicates data with the UE via the DU at block 810 (e.g., events 336, 340, 342, 344, 374).

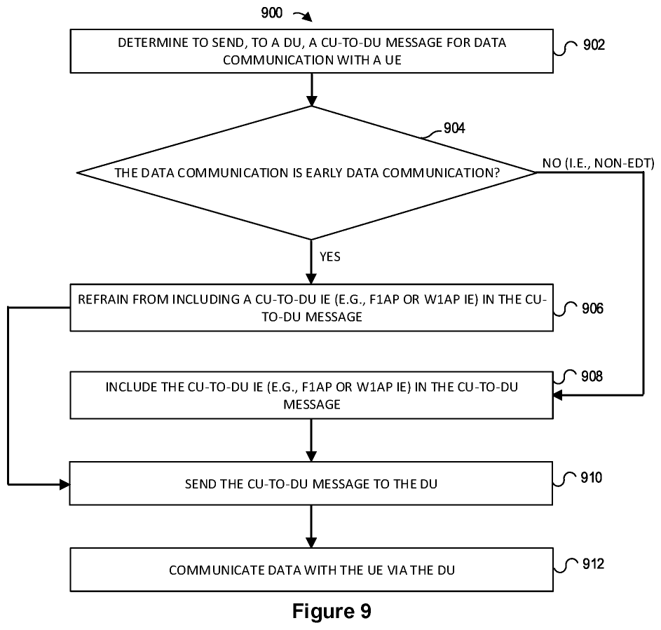

FIG. 9 is a flow diagram of a method 900, which is similar to the method 800, with some differences depending on implementation. At block 902, the CU determines to send, to a DU, a CU-to-DU message for data communication with a UE. At block 904, the CU determines whether the data communication is early data communication. If so, then at block 906 the CU refrains from including a CU-to-DU IE (e.g., a F1AP, W1AP IE, or an RRC IE) in the CU-to-DU message (e.g., the CU 172 may refrain from including the CU-to-DU IE in the CU-to-DU message the CU 172 transmits 333). The CU-to-DU IE may enable, or relate to, a radio function for communicating with a UE, as discussed with reference to block 602. Otherwise, at block 908, the CU includes the CU-to-DU IE in the CU-to-DU message (e.g., the CU 172 may include the CU-to-DU IE in the CU-to-DU message that the CU 172 transmits 356). The CU can then send the CU-to-DU message (either including or excluding the CU-to-DU IE) to the DU at block 910 (e.g., events 330, 333, 356), and communicate data with the UE via the DU at block 912 (e.g., events 336, 340, 342, 374).

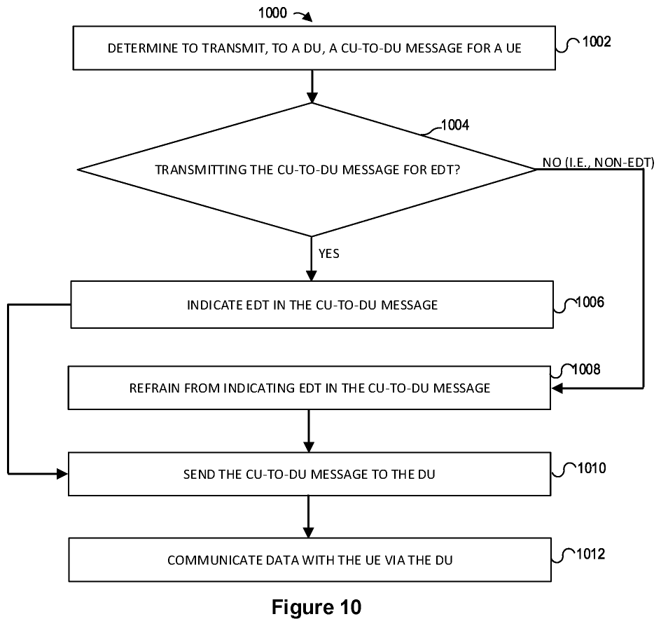

FIG. 10 is a flow diagram of a method 1000, which may augment the methods 800 and/or 900. At block 1002, the CU determines to transmit, to a DU, a CU-to-DU message for a UE. At block 1004, the CU determines whether the CU is transmitting the CU-to-DU message for performing EDT with the UE via the DU. If so, then the CU indicates EDT in the CU-to-DU message, at block 1006 (e.g., the CU 172 may include an EDT indication in the CU-to-DU message the CU 172 transmits 333). The CU can indicate EDT by including an EDT indication or EDT configuration for performing EDT in the CU-to-DU message, as discussed with reference to block 704. If the CU-to-DU message does not relate to performing EDT with the UE, then the CU, at block 1008, refrains from indicating EDT in the CU-to-DU message (e.g., the CU 172 may exclude an EDT indication from the CU-to-DU message that the CU 172 transmits 356). The CU can then send the CU-to-DU message to the DU at block 1010 (e.g., events 330, 333, 356), and communicate data with the UE via the DU at block 1012 (e.g., events 336, 340, 342, 374).

FIGS. 11A-11B are flow diagrams of example methods 1100A and 1100B, respectively, for transitioning a UE from an inactive state to a connected state, which can be implemented by a CU (e.g., the CU 172). Turning first to FIG. 11A, at block 1102, the CU receives, from a DU, a DU-to-CU message for performing EDT with a UE (e.g., event 326). The DU-to-CU message may include a UL RRC message indicating that the UE is initiating or performing EDT with the CU. At block 1104, in response to the DU-to-CU message and/or the UL RRC message, the CU performs an EDT-specific procedure with the DU in order to enable EDT operation. The CU may perform the EDT-specific procedure to request the DU to set up a UE context at the DU for EDT operation. In some implementations, the EDT-specific procedure is a procedure that the CU performs, instead of a UE Context Setup procedure (such as the UE Context Setup procedure performed at events 330 and 334, or events 333 and 334), to set up UL and/or DL tunnels with the DU to exchange UL and/or DL data with a UE when the UE operates in an inactive state (as opposed to the connected state). To perform the EDT-specific procedure with the DU, the CU can send an EDT request message to the DU. In response, the DU can send an EDT response message to the CU and enable EDT operation at the DU for the UE. The CU may include a first UE ID (e.g., gNB-CU UE F1AP ID or gNB-CU UE W1AP ID) in the EDT request message, and the DU may include a second UE ID (e.g., gNB-DU UE F1AP ID or gNB-DU W1AP ID) in the EDT response message. In other implementations, the EDT-specific procedure is a UE Context Setup procedure. To perform the EDT-specific UE Context Setup procedure with the DU, the CU can send a UE Context Setup Request message including an EDT indication to the DU. In response, the DU can send a UE Context Setup Response message to the CU and enable EDT operation for the UE.

At block 1106, the CU performs EDT with the UE, operating in an inactive state, via the DU (e.g., events 336, 338, 340, 342, 344). At block 1108, the CU performs a UE Context Modification procedure with the DU (e.g., events 356 and 360, 356 and 361, or 356 and 381). The CU may perform the UE Context Modification procedure to request the DU to set up a UE context at the DU for non-EDT operation. Performing the UE Context Modification procedure may include transmitting a UE Context Modification Request message to the DU, and receiving a UE Context Modification Response message from the DU. The CU may include the first UE ID and/or the second UE ID (i.e., if transmitted/received during the EDT-specific procedure at block 1104) in the UE Context Modification Request message, which enables the DU to identify UE context of the UE for EDT operation. At block 1110, the CU performs a non-EDT operation with the UE, operating in the connected state, via the DU (e.g., communicates data with the UE via the DU while the UE operates in a connected state) (e.g., events 374, 375, 373).

Turning to FIG. 11B, the method 1100B is initially similar to the method 1100A. However, at block 1107, rather than performing a UE Context Modification procedure (as at block 1108), the CU performs a UE Context Setup procedure in order to replace EDT with non-EDT operation for the UE. In some implementations, the DU releases the UE context for EDT operation and sets up a UE context for non-EDT operation in response to the UE Context Setup procedure. To perform the UE Context Setup procedure, the CU can send a UE Context Setup Request message to the DU, and receive a UE Context Setup Response message from the DU in response. In one implementation, the CU can include the first UE ID in the UE Context Setup Request message. In another implementation, the CU includes a third UE ID in the UE Context Setup Request message instead of the first UE ID.

In some implementations, at block 1109, the CU performs an EDT-specific release procedure with the DU to release the EDT operation before, during, or after the UE Context Setup procedure at block 1107. During the EDT-specific release procedure, the CU can send an EDT release command to the DU. In response, the DU releases the EDT operation and may send an EDT release complete message to the CU. In such implementations, the CU can include the first UE ID and/or the second UE ID (i.e., if transmitted/received during the EDT specific procedure at block 1104) in the EDT release command message.

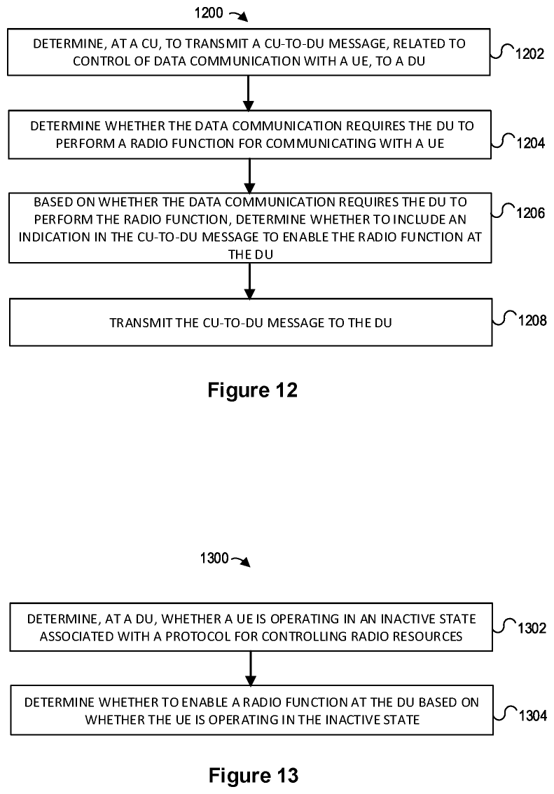

FIG. 12 is a flow diagram of a method 1200 for managing a radio function for communicating with a UE (e.g., the UE 102), which can be implemented by a CU (e.g., the CU 172) of a distributed base station (e.g., the base station 104) that includes the CU and a DU (e.g., the DU 174). At block 1202, the CU determines to transmit a CU-to-DU message, related to control of data communication with a UE, to a DU. The CU-to-DU message may be a request to set up a context of the UE (e.g., a UE Context Setup Request message) or a request to modify a context of the UE (e.g., a UE Context Modification message).

At block 1204, the CU determines whether the data communication requires the DU to perform the radio function. At block 1206, based on whether the data communication requires the DU to perform the radio function, the CU determines whether to include an indication in the CU-to-DU message to enable the function at the DU. At block 1208, the CU transmits the CU-to-DU message to the DU (e.g., events 330, 333, 356).

In response to determining that the data communication does not require the DU to perform the radio function, the CU excludes the indication from the CU-to-DU message (e.g., event 333). The CU may determine that the data communication does not require the DU to perform the radio function in response to determining that the data communication is early data communication. The CU may determine that the data communication is early data communication based on determining that the UE is operating in an inactive state associated with a protocol for controlling radio resources (e.g., RRC_INACTIVE). If the data communication is early data communication, the CU may include, in the CU-to-DU message, an indication that the CU is performing early data communication with the UE via the DU (e.g., an EDT indication or an EDT configuration for performing EDT) (e.g., blocks 1004-1008).

In some implementations in which the UE is operating in an inactive state, the CU may determine, after transmitting the CU-to-DU message, to transition the UE to a connected state associated with a protocol for controlling radio resources, and in response may perform a procedure with the DU to modify a context of the UE in order to communicate with the UE operating in the connected state. Performing the procedure may include transmitting a request to modify the context of the UE to the DU, the request including a first configuration for the radio function (e.g., event 356). In some implementations, the CU receives, from the DU in response to the request, a second configuration for the radio function, where at least a portion of the second configuration is different from the first configuration (e.g., event 361). In other implementations, the CU receives, from the DU in response to the request, a release configuration indicating to release the first configuration (e.g., event 381).

In response to determining that the data communication does require the DU to perform the radio function, the CU includes the indication in the CU-to-DU message (e.g., event 356). Determining that the data communication requires the radio function may include determining that the data communication is not early data communication, and/or that the UE is operating in the inactive state.

The radio function may be an operation for communicating with the UE when the UE is operating in a connected state associated with a protocol for controlling radio resources (e.g., RRC_CONNECTED). The radio function may be a discontinuous reception (e.g., DRX) operation, a measurement gap operation, or a reference signal transmission. In some implementations, the indication that the CU determines whether to include in the CU-to-DU message at block 1206 is a configuration for the radio function. The configuration may be an IE formatted in accordance with a protocol for controlling radio resources (e.g., the RRC protocol). For example, the indication may be a radio configuration that the UE can use to communicate with the DU. The radio function may be an operation that the DU performs that corresponds to the radio configuration. For example, the radio configuration may include a discontinuous reception configuration (e.g., DRX-Config IE), a measurement gap configuration (e.g., MeasGapConfig IE), or a CSI-RS or UE-specific reference signal configuration, and the corresponding radio function that the DU performs may be a discontinuous reception operation, a measurement gap operation, or a reference signal transmission. In other implementations, the indication that the CU determines whether to include in the CU-to-DU message at block 1206 is an IE formatted in accordance with a protocol for signaling between the CU and the DU (e.g., an F1AP IE or a W1AP IE) (e.g., blocks 904-908).

FIG. 13 is a flow diagram of a method 1300 for managing a radio function for communicating with a UE (e.g., the UE 102), which can be implemented by a DU (e.g., the DU 174) of a distributed base station (e.g., the base station 104) including the DU and a CU (e.g., the CU 172). At block 1302, the DU determines whether the UE is operating in an inactive state associated with a protocol for controlling radio resources. At block 1304, the DU determines whether to enable the radio function at the DU based on whether the UE is operating in the inactive state.

In response to determining that the UE is operating in the inactive state, the DU may refrain from enabling the radio function (e.g., event 332). Refraining from enabling the radio function may include refraining from applying a configuration for the radio function at the DU. Determining that the UE is operating in the inactive state may include determining that the DU is performing early data communication with the UE. The DU may determine that the DU is performing early data communication based on receiving, from the CU, an indication that the DU is performing early data communication (e.g., an EDT indication or an EDT configuration) (e.g., block 704). Additionally or alternatively, the DU may determine that the DU is performing early data communication based on receiving, from the UE, a protocol data unit including a message formatted in accordance with a protocol for controlling radio resources with an uplink data packet (e.g., event 324).

In response to determining that the UE is not operating in the inactive state, the DU may enable the radio function at the DU (e.g., event 358). Enabling the radio function may include applying a configuration for the radio configuration at the DU (e.g., event 358).

In some implementations, the DU determines whether to enable the radio function in response to receiving a CU-to-DU message from the CU related to control of data communication with the UE (e.g., events 330, 333, 356). In such implementations, determining whether to enable the radio function may be further based on whether the data communication requires the DU to perform the radio function. The CU-to-DU message may be a request to set up a context or to modify a context of the UE. Further, the CU-to-DU message may include a configuration for the radio configuration. The configuration may be an IE formatted in accordance with a protocol for controlling radio resources. Additionally or alternatively, the CU-to-DU message may include an IE formatted in accordance with a protocol for signaling between the CU and the DU, the IE for enabling the radio function for communicating with the UE (e.g., block 602).

The following list of examples reflects a variety of the embodiments explicitly contemplated by the present disclosure.

Example 1. A method in a central unit (CU) of a distributed base station, the distributed base station including the CU and a distributed unit (DU), for managing a radio function for communicating with a UE, the method comprising: determining, by processing hardware of the CU, to transmit a CU-to-DU message, related to control of data communication with the UE, to the DU; determining, by the processing hardware, whether the data communication requires the DU to perform the radio function; based on whether the data communication requires the DU to perform the radio function, determining, by the processing hardware, whether to include an indication in the CU-to-DU message to enable the radio function at the DU; and transmitting, by the processing hardware, the CU-to-DU message to the DU.

Example 2. The method of example 1, further comprising: in response to determining that the data communication does not require the DU to perform the radio function, excluding the indication from the CU-to-DU message.

Example 3. The method of example 2, wherein determining that the data communication does not require the DU to perform the radio function includes determining that the data communication is early data communication.

Example 4. The method of example 3, wherein determining that the data communication is early data communication includes determining that the UE is operating in an inactive state associated with a protocol for controlling radio resources.

Example 5. The method of example 3 or 4, wherein the indication is a first indication, the method further comprising: including, in the CU-to-DU message, a second indication indicating that the CU is performing early data communication with the UE via the DU.

Example 6. The method of example 3, further comprising: determining, after transmitting the CU-to-DU message, to transition the UE to a connected state associated with a protocol for controlling radio resources; and performing a procedure with the DU to modify a context of the UE to communicate with the UE operating in the connected state.

Example 7. The method of example 6, wherein performing the procedure includes: transmitting a request to modify the context of the UE to the DU, the request including a first configuration for the radio function; and receiving, from the DU in response to the request, a second configuration for the radio function, wherein at least a portion of the second configuration is different from the first configuration.

Example 8. The method of example 6, wherein performing the procedure includes: transmitting a request to modify the context of the UE to the DU, the request including a first configuration for the radio function; and receiving, from the DU in response to the request, a release configuration indicating to release the first configuration.

Example 9. The method of example 1, further comprising: in response to determining that the data communication requires the radio function, including the indication in the CU-to-DU message.

Example 10. The method of example 9, wherein determining that the data communication requires the radio function includes determining that the data communication is not early data communication.

Example 11. The method of any one of the preceding examples, wherein the radio function is for communicating with the UE when the UE is operating in a connected state associated with a protocol for controlling radio resources.

Example 12. The method of any one of examples 1-11, wherein the radio function is a discontinuous reception operation.

Example 13. The method of any one of examples 1-11, wherein the radio function is a measurement gap operation.

Example 14. The method of any one of examples 1-11, wherein the radio function is a reference signal transmission.

Example 15. The method of any one of the preceding examples, wherein transmitting the CU-to-DU message includes: transmitting a request to set up a context of the UE.

Example 16. The method of any one of the preceding examples, wherein the indication includes a configuration for the radio function.

Example 17. The method of example 16, wherein the configuration is an information element formatted in accordance with a protocol for controlling radio resources.

Example 18. The method of any one of examples 1-15, wherein the indication includes an information element formatted in accordance with a protocol for signaling between the CU and the DU.

Example 19. A method in a distributed unit (DU) of a distributed base station, the distributed base station including the DU and a central unit (CU), for managing a radio function for communicating with a UE, the method comprising: determining, by processing hardware of the DU, whether the UE is operating in an inactive state associated with a protocol for controlling radio resources; determining, by the processing hardware, whether to enable the radio function at the DU based on whether the UE is operating in the inactive state.

Example 20. The method of example 19, further comprising: in response to determining that the UE is operating in the inactive state, refraining from enabling the radio function.

Example 21. The method of example 20, wherein refraining from enabling the radio function includes refraining from applying a configuration for the radio function at the DU.

Example 22. The method of example 20 or 21, wherein determining that the UE is operating in the inactive state includes determining that the DU is performing early data communication with the UE.

Example 23. The method of example 22, wherein determining that the DU is performing early data communication includes: receiving, from the CU, an indication that the DU is performing early data communication.

Example 24. The method of example 22, wherein determining that the DU is performing early data communication includes: receiving, from the UE, a protocol data unit including a message formatted in accordance with a protocol for controlling radio resources with an uplink data packet.

Example 25. The method of example 19, further comprising: in response to determining that the UE is not operating in the inactive state, enabling the radio function.

Example 26. The method of example 25, wherein enabling the radio function includes applying a configuration for the radio function at the DU.

Example 27. The method of any one of example 19-26, wherein the radio function is for communicating with the UE when the UE is operating in a connected state associated with the protocol for controlling radio resources.

Example 28. The method of any one of examples 19-27, wherein the radio function is a discontinuous reception operation.

Example 29. The method of any one of examples 19-27, wherein the radio function is a measurement gap operation.

Example 30. The method of any one of examples 19-27, wherein the radio function is a reference signal transmission.

Example 31. The method of example 19, further comprising: receiving, from the CU, a CU-to-DU message related to control of data communication with the UE; wherein the determining whether to enable the radio function is in response to receiving the CU-to-DU message.

Example 32. The method of example 31, wherein determining whether to enable the radio function is further based on whether the data communication requires the DU to perform the radio function.

Example 33. The method of example 31 or 32, wherein receiving the CU-to-DU message includes: receiving a request to set up a context of the UE.

Example 34. The method of any one of examples 31-33, wherein the CU-to-DU message includes a configuration for the radio function.

Example 35. The method of example 34, wherein the configuration is an information element formatted in accordance with the protocol for controlling radio resources.

Example 36. The method of any one of examples 31-33, wherein the CU-to-DU message includes an information element formatted in accordance with a protocol for signaling between the CU and the DU, the information element for enabling the radio function for communicating with the UE.

Example 37. A network node of a radio access network (RAN) including processing hardware and configured to implement a method according to any one of the preceding examples.

The following description may be applied to the description above.

In some implementations, “message” is used and can be replaced by “information element (IE)”. In some implementations, “IE” is used and can be replaced by “field”. In some implementations, “configuration” can be replaced by “configurations” or the configuration parameters. In some implementations, “early data communication” can be replaced by “small data communication” and “early data transmission” can be replaced by “small data transmission”. In some implementations, “communicating data via RB(s)” can be replaced by “communicate data associated to RB(s)” or “communicate data on RB(s)”. “communicate” can be replaced by “transmit”, “receive” or “transmit and receive”.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

1. A method implemented in a central unit (CU) of a distributed base station, the distributed base station including the CU and a distributed unit (DU), the method comprising:
generating, by the CU, a CU-to-DU message, related to control of data communication with the UE, the generating including:
when the data communication with the UE requires the DU to perform a radio function which includes one of (i) a discontinuous reception operation, (ii) a measurement gap operation, or (iii) a reference signal transmission, including an indication in the CU-to-DU message to enable the radio function, and
when the data communication with the UE does not require the DU to perform the radio function, excluding the indication from the CU-to-DU message; and transmitting, from the CU to the DU, the CU-to-DU message.

2. The method of claim 1, further comprising:
determining that the data communication requires the DU to perform the radio function when the data communication is not early data communication; or
determining that the data communication does not require the DU to perform the radio function when the data communication is early data communication.

3. (canceled)

4. The method of claim 1, wherein transmitting the CU-to-DU message includes:
transmitting a request to set up a context of the UE.

5. The method of claim 1, wherein the indication includes a configuration for the radio function.

6. The method of claim 5, wherein the configuration is an information element formatted in accordance with a protocol for controlling radio resources.

7. A method implemented in a distributed unit (DU) of a distributed base station, the distributed base station including the DU and a central unit (CU), the method comprising:
determining, by the DU, whether the UE is operating in an inactive state associated with a protocol for controlling radio resources;
when the UE is operating in the inactive state, refraining from enabling a radio function at the DU, the radio function including one of (i) a discontinuous reception operation, (ii) a measurement gap operation, or (iii) a reference signal transmission; and
when the UE is not operating in the inactive state, enabling the radio function at the DU.

8. The method of claim 7, wherein refraining from enabling the radio function includes refraining from applying a configuration for the radio function at the DU.

9. The method of claim 8, wherein determining that the UE is operating in the inactive state includes determining that the DU is performing early data communication with the UE.

10. The method of claim 7, wherein enabling the radio function includes applying a configuration for the radio function at the DU.

11. (canceled)

12. The method of claim 7, further comprising:
receiving, from the CU, a CU-to-DU message related to control of data communication with the UE;
wherein the enabling or the refraining from enabling the radio function is in response to receiving the CU-to-DU message.

13. The method of claim 12, wherein receiving the CU-to-DU message includes: receiving a request to set up a context of the UE.

14. The method of claim 12, wherein the CU-to-DU message includes an information element formatted in accordance with a protocol for signaling between the CU and the DU, the information element for enabling the radio function for communicating with the UE.

15. A distributed unit (DU) of a distributed base station, the DU including processing hardware and configured to:
determine, by the DU, whether the UE is operating in an inactive state associated with a protocol for controlling radio resources;
when the UE is operating in the inactive state, refrain from enabling a radio function at the DU, the radio function including one of (i) a discontinuous reception operation, (ii) a measurement gap operation, or (iii) a reference signal transmission; and
when the UE is not operating in the inactive state, enable the radio function at the DU.

16. The DU of claim 15, wherein to refrain from enabling the radio function, the DU is configured to:
refrain from applying a configuration for the radio function at the DU.

17. The DU of claim 16, wherein to determine that the UE is operating in the inactive state, the DU configured to:
determine that the DU is performing early data communication with the UE.

18. The DU of claim 15, wherein to enable the radio function, the DU is configured to:
apply a configuration for the radio function at the DU.

19. The DU of claim 15, wherein the DU is further configured to:
receive, from the CU, a CU-to-DU message related to control of data communication with the UE;
wherein the enabling or the refraining from enabling the radio function is in response to receiving the CU-to-DU message.

20. The DU of claim 15, wherein to receive the CU-to-DU message, the DU is configured to:
receive a request to set up a context of the UE.

21. The DU of claim 15, wherein the CU-to-DU message includes an information element formatted in accordance with a protocol for signaling between the CU and the DU, the information element for enabling the radio function for communicating with the UE.
